(19) United States
(12) Patent Application Publication
(10) Pub. No.: US 2025/0200014 A1
(43) Pub. Date: Jun. 19, 2025

(54) DYNAMIC ARTIFICIAL INTELLIGENCE-BASED BLUEPRINTING GENERATION AND EXECUTION PLATFORM

(71) Applicant: C3.ai, Inc., Redwood City, CA (US)

(72) Inventors: Edward Y. ABBO, Woodside, CA (US); Nikhil KRISHNAN, Los Altos, CA (US); Romain JUBAN, San Francisco, CA (US); Louis POIRIER, Paris (FR); Franklin Q. YE, San Francisco, CA (US); Ken IKEDA, Redwood City, CA (US)

(21) Appl. No.: 18/984,498

(22) Filed: Dec. 17, 2024

Related U.S. Application Data
(60) Provisional application No. 63/611,736, filed on Dec. 18, 2023.

(51) Int. Cl. G06F 16/21; G06F 16/2452

(52) U.S. Cl. CPC G06F 16/213; G06F 16/24522

(57) ABSTRACT

Disclosed herein are system, method, and computer program product aspects for a schema management platform. An aspect operates by leveraging artificial intelligence for generating and executing schemas. An aspect operates by also providing functionality for generating code for a schema. The schema management platform may be used to assist real-world workflows and procedures performed in particular contexts. In some aspects, the schema management platform can utilize a schema to instruct a multimodal model on how to respond with verifiable subject matter expertise to various types of inputs and use cases. As such, the schema management platform may provide more accurate and reliable results compared to conventional systems.

### CROSS-REFERENCE TO RELATED APPLICATIONS

This application claims the benefit of U.S. Provisional Application No. 63/611,736, filed Dec. 18, 2023, the disclosure of which is incorporated by reference herein in its entirety.

### BACKGROUND

Machine learning models provide various functionalities, such as classification and prediction. A category of machine learning models that has recently become more popular is large language models (LLMs), which can perform various natural language processing (NLP) tasks, such as generating content, producing machine translations, summarizing documents, and answering specific queries. LLMs are popular because they provide an accessible and versatile way to interface with machines through unimodal or multimodal natural language inputs and outputs. They are also able to draw from vast arrays of information, since they are typically trained on enormous amounts of diverse data ranging from website content, software code, news articles, video transcripts, and electronic books. However, despite these advantages, conventional LLMs and language models suffer from a variety of technical problems surrounding high amounts of compute during training and runtime, response variability and inconsistency, and context voids with respect to specialized subject matter, which can have devastating repercussions in real-world use cases.

### BRIEF DESCRIPTION OF THE DRAWINGS

The accompanying drawings are incorporated herein and form a part of the specification.

FIG. 1 illustrates an example block diagram of a schema management platform architecture, according to some aspects.

FIG. 2 illustrates an example block diagram of a system for generating a schema, according to some aspects.

FIG. 3 illustrates an example block diagram of a system for executing a schema, according to some aspects.

FIG. 4 illustrates an example block diagram of a system for generating code for a schema, according to some aspects.

FIGS. 5A-5B illustrate example schemas, according to some aspects.

FIGS. 6A-6B illustrate additional example schemas, according to some aspects.

FIG. 7 illustrates an example flow diagram for generating a schema, according to some aspects.

FIG. 8 illustrates an example flow diagram for executing a schema, according to some aspects.

FIG. 9 illustrates an example flow diagram for generating code for a schema, according to some aspects.

FIG. 10 illustrates another example flow diagram for generating a schema, according to some aspects.

FIG. 11 illustrates another example flow diagram for generating code for a schema, according to some aspects.

FIG. 12 illustrates an example computer system useful for implementing various aspects.

In the drawings, like reference numbers generally indicate identical or similar elements. Additionally, generally, the left-most digit(s) of a reference number identifies the drawing in which the reference number first appears.

### DETAILED DESCRIPTION

Blueprints serve as detailed guides that outline the steps or information needed to solve complex problems. By providing a clear and structured knowledge, blueprinting help ensure that solutions are both efficient and accurate. Disclosed herein are system, apparatus, device, method and/or computer program product aspects, and/or combinations and sub-combinations thereof for implementing a schema management platform, which may leverage artificial intelligence for generating and executing schemas for knowledge blueprinting. A schema includes a deterministic sequence of actions that can be used for performing a procedure in a particular context or context-specific scenario. Schemas can capture knowledge, experiences, or instructions for a particular context or context-specific scenario. This approach allows developers and engineers to navigate challenges systematically, reducing errors and improving outcomes. Schemas can act like a blueprint with structured outlines or templates for knowledge capture to guide a design or solution through a contextual challenge. The insights and information encapsulated in a blueprint or schema provide valuable guidance for executing a process. This structured knowledge ensures that each step is well-informed and aligned with best practices, leading to more efficient and accurate outcomes. The schema management platform may be used to assist real-world workflows and procedures performed in particular contexts, for example.

The schema management system can be viewed as an architecture for storing fractional subject matter knowledge with blueprints or schemas to allow for the modularization of knowledge into discrete, manageable units that can be easily accessed and utilized by machine learning models. By breaking down complex information into smaller, context-specific schemas, the platform can efficiently store and retrieve knowledge as needed. This modular approach not only enhances the flexibility and scalability of the system but also ensures that the knowledge remains up-to-date and relevant, as individual schemas can be updated or replaced without overhauling the entire system.

The schema management system enables machine learning models to leverage these schemas to generate contextual workflows, answers, or recommendations for non-subject matter experts. By integrating schemas into the learning process, models can draw on a vast repository of structured knowledge to provide accurate and contextually appropriate responses. This capability is particularly valuable in scenarios where users may not have deep expertise in a particular domain but still require reliable and informed guidance. The use of schemas ensures that the recommendations are grounded in best practices and comprehensive knowledge, thereby enhancing the overall quality and reliability of the outputs.

In addition, the schema management platform's architecture supports continuous learning and improvement. As new information and experiences are captured in the form of schemas, the platform can evolve and adapt to changing contexts and requirements. This dynamic nature allows the system to remain relevant and effective over time, providing users with up-to-date and contextually accurate information. By facilitating the seamless integration of new knowledge, the platform ensures that machine learning models can continually refine their outputs, leading to more precise and effective solutions for a wide range of applications.

Machine learning models can include some or all of the different types or modalities of models described herein (e.g., multimodal machine learning models, large language models, data models, statistical models, audio models, visual models, audiovisual models, etc.). For example, transformer-based multimodal models are one category of machine learning models that have emerged as useful tools for performing various tasks, such as generating content, producing machine translations, summarizing documents, and answering specific queries. Multimodal models are appreciated as they provide a natural language interface and access to the large quantities of information on which they are trained, which may range from website content and software code to news articles and electronic books. However, despite these advantages, conventional multimodal models suffer from a variety of technical problems that place restrictions on practical use in specialized contexts, such as in industrial settings. Data formats can include some or all of the different types or modalities described herein (e.g., multimodal, text, coded, language, statistical, audio, visual, audiovisual, etc.).

A primary technical challenge faced by conventional multimodal models is the high computational overhead that is required during both training and runtime. Conventionally, multimodal models are developed by first training one or more “foundation models,” which are models that are trained on billions or even trillions of parameters to perform general tasks, such as understanding language, generating text and images, and conversing in natural language. These foundation models can then be used “off-the-shelf”, or they can be further trained to perform more specialized tasks, a process that is referred to as “fine-tuning.” Generally, fine-tuning involves updating the internal parameters of a model using additional data that was procured specifically to teach some task to a model. The result would be a machine learning model (e.g. fine-tuned multimodal model) that can understand the general concepts learned from the original training process and the context specific concepts distilled during the fine-tuning process.

However, in either case, the process in obtaining the final model requires exorbitant amounts of computational resources to find the set of internal model parameters that yield the best results. Additionally, achieving satisfactory results typically requires special hardware configurations and high power consumption to train these models. These computational overheads then extend to model deployment, where real-time inference also requires high-performance hardware, memory, and processing power.

Furthermore, the statistical nature of these models introduces inherent variability and inconsistency across outputs. This means that while most of the time a multimodal model may provide a similar response to the same query, there is a chance that a multimodal model-based on whether certain internal activation conditions are met and what types of data were used during training—may provide completely different and sometimes even contradictory responses to the same query. Multimodal models are only as accurate as the data on which they were trained. Then, because large amounts of data (that may or may not always be true) are used to train a multimodal model, the multimodal model may respond with the “most statistically correct” answer to a user query but the response could be completely wrong from being backed by false data. This characteristic can have devastating effects in real-world scenarios, such as industrial or manufacturing applications, where a single inaccuracy or defect can have domino effects leading to malfunction of entire systems.

A related technical challenge faced by multimodal models is the problem of hallucinations. Hallucinations reflect a tendency by multimodal models to produce content that is either inconsistent with real-world facts and user inputs or potentially misleading. Thus, while the technical problem discussed above relates to inconsistency across user queries, hallucinations are inconsistencies between a standalone multimodal model response and the facts on which the multimodal model was trained. There are nearly endless causes for hallucinations, but in general, hallucinations occur due to flawed data sources, non-optimal training, and decoding randomness during inference.

Although the systems and processes described herein reference text-based language models for ease of example, it will be appreciated that different types of machine learning models may be used instead of, or in addition to, text-based language models. For example, a schema management platform may use deep learning models specifically designed to additionally or alternatively receive non-natural language inputs (e.g., images, video, audio) and provide natural language outputs (e.g., summaries) and/or other types of output (e.g., a video summary). Accordingly, the term “multimodal models” as used herein refers to unimodal and multimodal models such as transformer-based models, large language models, and the like.

A flawed data source (e.g. untrue statements) used for training can lead to potential fact-related hallucinations during inference. Hallucinations from non-optimal training can stem from an unrealistic emphasis on fulfilling user queries during training, especially in cases when the user query is asking for the impossible. For example, a user query may ask a multimodal model to use mathematical principles to prove that “1=2” during inference. Depending on how the multimodal model was trained, the multimodal model may start explaining how it could be possible to prove that “1=2,” rather than simply replying that it is impossible to prove mathematically that “1=2.” With respect to decoding randomness, during the inference process, multimodal models typically rely on a stochastic (e.g. random) sampling strategy to formulate word sequences. This strategy generally leads to higher accuracy responses, but because of the randomness factor, multimodal models suffer from the hallucinations that may occur as a result.

A further technical problem faced by multimodal models concerns limitations in specific technical contexts, such as industrial machinery environments. These models shine when operating in broad, general domains but lack deep, accurate, and contextual understanding of specific industrial processes, control sequences, and troubleshooting operations (e.g. “subject matter expertise”). This void becomes especially apparent when multimodal models start to interface with proprietary systems and specialized machinery about and on which there is little to no public information to train. Here, the fine-tuning process discussed above can serve as a potential stopgap. However, systems may encounter the high training costs to curate and run custom datasets through the models. Additionally, fine-tuning typically is most helpful when training for one specific task. However, training over an entire technical context that could potentially involve many different tasks is infeasible at scale and would require further computational resources and memory to accomplish.

Continuing the discussion regarding specialized technical contexts, yet another technical problem faced by conventional multimodal models is an inability to protect sensitive data. As discussed previously, the initial training process for a conventional foundation model involves ingesting vast amounts of public data. However, oftentimes these specialized technical contexts involve proprietary data and enterprise specific information. When these types of materials are included in the initial training process, a potential bad actor can mine the multimodal model for potentially sensitive information during inference.

Aspects of the disclosure herein solve these technological problems by implementing a schema management platform. A blueprint or schema as used herein may refer to a deterministic sequence of actions for performing a procedure in a particular context or context-specific scenario. To provide a few examples, which are not meant to be limiting, a schema may outline a certain process, procedure, instruction set, troubleshooting guide, or workflow in a particular context (e.g. diagnosing issues with a malfunctioning industrial machine). Schemas can also include, and are not limited to, knowledge about subject matter expertise, contextual knowledge, specific reinforced learning, command and control sequences, and error resolutions. In some aspects, the schema management platform may define, generate, identify, predict, or manage a variety of different schemas. The schema management platform may leverage machine learning models such as multimodal models, language models and large language models to provide more accurate and reliable results compared to conventional implementations without the need for computationally expensive and inefficient retraining and inference processes.

The schema management platform can utilize a schema or blueprint to instruct a multimodal model on how to respond with verifiable subject matter expertise to various types of inputs and specific use cases. For example, a multimodal model is employed to provide customized recommendations for an industrial or manufacturing operation for a specific machine or routine that is informed by a relevant schema. As a part of this process, the relevant schema would impart specific subject matter knowledge for the associated machine, problem, or context. The schema management platform may include various input modes and model modalities including, but not limited to, text-based large language models, multimodal large language models, multimodal machine learning models, data models, statistical models, audio models, visual models, and audiovisual models. The schema management platform may also support simplified human-computer interactions via a natural language interface including adaptable forms of input including, but not limited to, text, audio, images, and more.

In some aspects, the schema management platform may provide functionality for generating a schema, for example, via artificial intelligence. The schema management platform may receive a first natural language query identifying a target procedure in a particular context. The schema management platform may then determine a schema for the target procedure from among a plurality of stored schemas based on the first natural language query. The schema management platform may then construct a second natural language query based on the first natural language query and the reference schema. The schema management platform may then send the second natural language query to a multimodal model. The schema management platform may then receive an initial output schema defining an initial action sequence for performing the target procedure. The schema management platform may then verify a determinism of the initial action sequence. Then, the schema management platform may generate, based on the verifying, a final output schema that defines a deterministic action sequence for performing the target procedure. The final output schema may provide a deterministic result when executed. In other words, the final output schema may generate the same output any time it is given the same input state.

Schemas may be recorded or programmed for specific operational tasks, routines, equipment, and real-time variables (e.g. environmental, sensor, logging, etc.). Schemas may also provide a link between a data model and various real world objects to facilitate training to scale for new use cases. For example, a generative artificial intelligence system, in processing a query, may ingest various knowledge sources including, but not limited to, operating manuals, enterprise repositories, and subject matter expert information. Using this information, a schema management platform may reference subject matter expertise stored in a first set of documents to produce schemas for separate but related use cases.

In some aspects, the schema management platform may provide functionality for executing a schema. The schema management platform may first receive a natural language query identifying a target procedure. For example, this may occur in response to a user query describing a particular procedure. The schema management platform may then determine, based on the natural language query, a relevant schema for the target procedure. The relevant schema may define a deterministic action sequence for performing the target procedure. The schema management platform may then assign, by an orchestrator, a plurality of agents to execute the relevant schema. The schema management platform may then instruct a first agent to perform a first action of the deterministic action sequence defined by the relevant schema. As a result, an agent decision may be obtained. The schema management platform may then determine, based on the agent decision, one or more additional actions within the deterministic action sequence to perform. The schema management platform may then instruct one or more additional agents to perform the one or more additional actions. As a result, a final schema result may be obtained. Then, the schema management platform may complete the target procedure based on the final schema result.

In some aspects, the schema management platform may provide functionality for generating a machine-executable instruction or code corresponding to an action or step of a schema. The schema management platform may first send, to a multimodal model, a first query for generating a machine-executable instruction for performing an action within a deterministic action sequence defined in a schema. The schema management platform may then receive a generated machine-executable instruction based on the first query. The schema management platform may then send a second query for validating whether the generated instruction performs the action when executed. The second query may request a semantic analysis of the generated instruction.

The schema management platform may then receive a positive validation result indicating that the generated instruction performs the action when executed. The schema management platform may then send a third query for generating a unit test that specifies a pass condition. The schema management platform may then receive a generated unit test for the generated instruction. The generated unit test may serve as a programmatic analysis of the generated instruction. The schema management platform may then obtain, by executing the unit test, a positive unit test result indicating that the generated instruction fulfills the pass condition. Then, the schema management platform may assign the generated instruction to the action. As a result, any subsequent execution of the action (e.g. during an execution of the associated schema) would cause the generated instruction to be executed.

These approaches provide direct technological improvements over previous systems via an implementation that curbs the inherent randomness and variability of generative artificial intelligence systems. These approaches also leverage the creativity and adaptability of multimodal models while providing deterministic and repeatable frameworks for procedures in particular contexts. Furthermore, because these techniques do not require any retraining of the multimodal model, sensitive, proprietary data may be protected from bad actors that try to mine a foundation model for such information.

The techniques described herein also improve the functioning of a computing system. Schemas can provide for improved and faster retrieval and selection of preferred outputs and responses by generative artificial intelligence systems. In previous implementations, a multimodal model or other language model would require extensive compute resources and time to obtain generalized, non-contextualized responses. However, the aspects described herein may ingest or execute a schema to efficiently and accurately respond to these same queries using any processes, procedures, instructions, troubleshooting guides, workflows, and any other information defined in the schema. This saves the computational time and resources that would otherwise have been expended during inference to formulate responses to user queries. Furthermore, while the conservation of computational resources may be relatively minimal with respect to a single client device, the total conservation of computational resources across an entire fleet of client devices may be significant.

These technical advantages may be appreciated, for example, in resource-constrained environments and target, complex use cases. The overall computational efficiency of these systems may be improved as a result and the conserved resources may be reallocated for other tasks. Additionally, the deterministic, repeatable, and robust nature of schemas may translate to fewer computational errors and higher performance accuracy.

In the realm of advanced data management and artificial intelligence, the ability to efficiently process and execute complex procedures is paramount. Example implementations include an innovative approach where a schema management system leverages multi-modal models to handle intricate queries. By identifying a target procedure within a specific context, the system can reference a stored schema that encapsulates the necessary knowledge for the task. An example method ensures that the generated instruction prompts are highly relevant and tailored to the context, facilitating precise and effective execution.

The multi-modal model plays a crucial role in this process, utilizing various agents to interpret and act upon the instruction prompts. These agents can iteratively generate additional prompts, refining the workflow to achieve optimal results. The outcome is a deterministic action sequence that defines the steps required to perform the target procedure accurately. This approach not only enhances the efficiency of executing complex tasks but also underscores the potential of integrating schema management with advanced AI models to drive innovation in data processing and automation.

In an example implementation, a query can be received that identifies a target procedure in a particular context. The schema management system can determine, based on the query, a reference schema for the target procedure from among a stored schemas, where each schema of the plurality of stored schemas includes knowledge for performing a respective procedure in a respective context. An instruction prompt is generated based on the query and at least the reference schema, and a target context. The instruction prompt is processed by multi-modal model. The multi-modal model can employ one or more agents to action the instruction prompt. In some implementations, the agents can generate additional prompts for iterative processing with the multi-modal model. The multi-modal model outputs a workflow based on the instruction prompt, the workflow defining a deterministic action sequence for performing the target procedure.

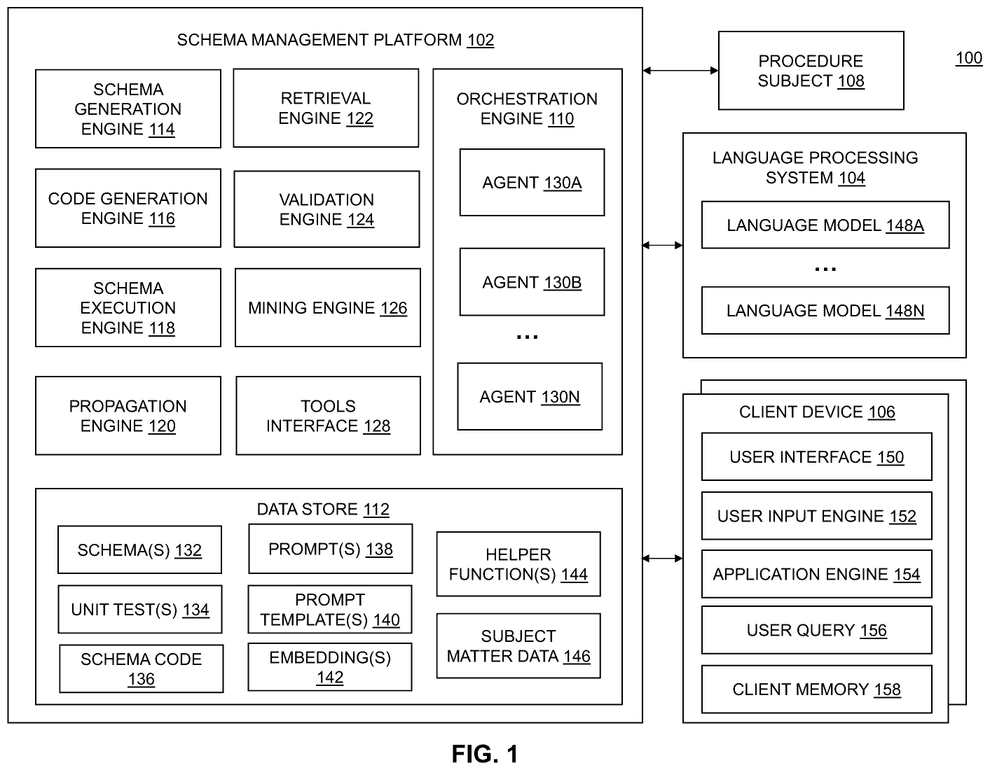

Various aspects of this disclosure may be implemented using and/or may be a part of the example schema management platform shown in FIGS. 1-4. It is noted, however, that these environments are provided solely for illustrative purposes, and are not limiting. Aspects of this disclosure may be implemented using and/or may be part of environments different from and/or in addition to the schema management platform, as will be appreciated by persons skilled in the relevant art(s) based on the teachings contained herein.

FIG. 1 illustrates an example block diagram of a schema management platform architecture 100, according to some aspects. Operations described may be implemented by processing logic that may comprise hardware (e.g. circuitry, dedicated logic, programmable logic, microcode, etc.), software (e.g. instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Example schema management platform architecture 100 may include a schema management platform 102, a language processing system 104, client device 106, and a procedure subject 108. In some aspects, example schema management platform architecture 100 may be implemented partially or entirely at client device 106. Alternatively or additionally, in some aspects, example schema management platform architecture 100 may be implemented partially or entirely at third party servers or within the cloud. In such aspects, client device 106, schema management platform 102, language processing system 104, and procedure subject 108 may be communicatively coupled with each other via one or more networks, such as one or more wired or wireless local area networks (“LANs,” including Wi-Fi, mesh networks, Bluetooth, near-field communication, etc.) or wide area networks (“WANs”, including the Internet).

In some aspects, schema management platform 102 may include a schema generation engine 114, a code generation engine 116, a schema execution engine 118, a propagation engine 120, a retrieval engine 122, a validation engine 124, a mining engine 126, a tools interface 128, an orchestration engine 110, and a data store 112. In some aspects, schema management platform 102 may be implemented as one or more servers and/or one or more cloud servers. Schema management platform 102 may also be implemented as a variety of centralized or decentralized computing devices. For example, schema management platform 102 may operate on a mobile device, a laptop computer, a desktop computer, grid-computing resources, a virtualized computing resource, cloud computing resources, peer-to-peer distributed computing devices, a server farm, or a combination thereof. Schema management platform 102 may be centralized in a single device, distributed across multiple devices within a cloud network, distributed across different geographic locations, or embedded within a network.

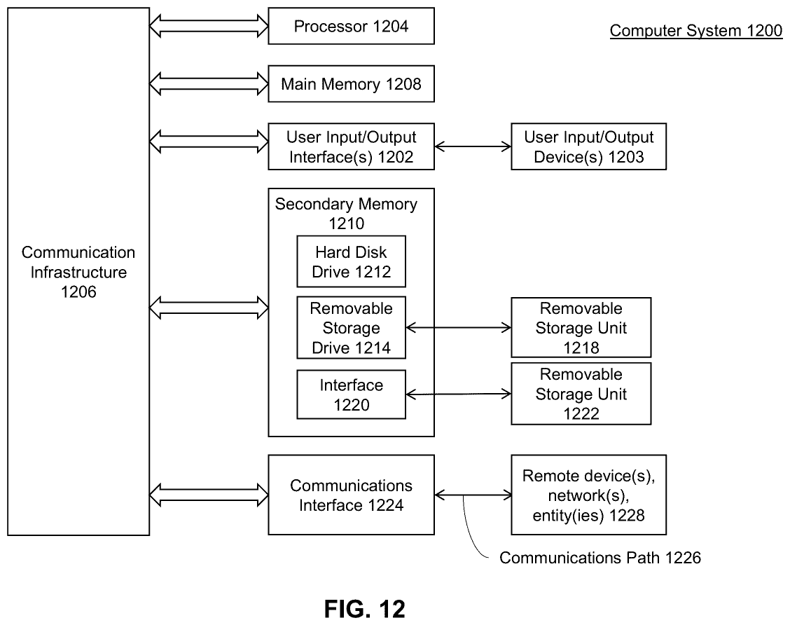

In some aspects, data store 112 may store various data used by schema management platform 102, including schema(s) 132, unit test(s) 134, schema code 136, prompt(s) 138, prompt template(s) 140, embedding(s) 142, helper function(s) 144, and subject matter data 146. Data store 112 may be stored, for example, in a volatile memory (e.g. random access memory (RAM)), a non-volatile storage device (e.g. a disk), or in a distributed and/or redundant manner across multiple memories and/or storage devices. In some aspects, data store 112 is managed by and accessed via a corresponding database management system (DBMS), which is not shown in FIG. 1 for the sake of simplicity. Data store 112 and the corresponding DBMS may be implemented on one or more computer systems, such as computer system 1200 as described below in reference to FIG. 12. Data store 112 and the corresponding DBMS may also be implemented on one or more servers of an enterprise network and/or a cloud computing network.

As described above, schema(s) 132 may define deterministic sequences of actions for performing a procedure in a particular context or context-specific scenario. Schema(s) 132 may include certain processes, procedures, instruction sets, troubleshooting guides, or workflows in particular contexts. In some aspects, schema(s) 132 may define conditional or branching deterministic action sequences. For example, schema(s) 132 may provide detailed and precise instructions in a decision tree or flowchart style for diagnosing issues with specific corresponding malfunctioning industrial machines (e.g. procedure subject 108). Alternatively or additionally, schema(s) 132 may define sequential or linear deterministic action sequences.

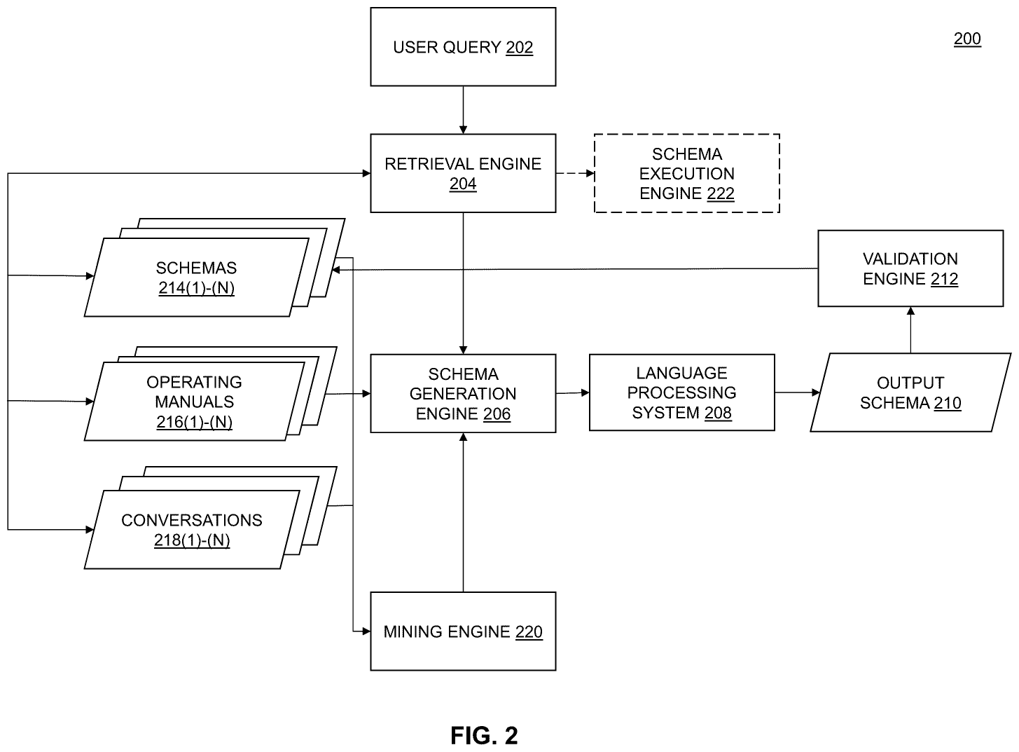

Procedure subject 108 may refer to the subject of a schema towards which one or more actions defined by the associated schema are directed. In some aspects, schema(s) 132 may be stored in JavaScript Object Notation (JSON) format. Schema(s) 132 may also reflect specific subject matter and control sequences that are typically only available to subject matter experts. A schema provided by such experts may be referred to as a user-created schema. However, schemas that are inferred or generated, for example via schema generation engine 114, may be referred to as system-created schemas. Schema generation engine 114 may interface with various components in schema management platform 102 to generate a system-created schema, a process that will be explained in further detail hereafter, particularly with respect to FIG. 2.

Language processing system 104 may be a distributed computing system configured to execute one or more natural language machine learning models, language models 148A-148N (collectively, “language models 148”). In some aspects, language models 148 may be transformer and/or neural network based multimodal models (including unimodal models) trained on large amounts of data (e.g. text, image, video, audio, etc.). Additionally or alternatively, language models 148 may include a large language model or a small language model. Language models 148 may also be trained on different modalities of data, including but not limited to, audio, image, and video data. Language models 148 may employ various model architectures including, but not limited to, encoder-decoder, causal decoder, and prefix decoder architectures. Various components of schema management platform 102 may interface with language processing system 104 and language models 148 to perform various tasks, such as interpreting user queries (e.g. user query 156), generating and executing schemas, generating schema code, and validating schema code.

In some aspects, language processing system 104 may generate a report in response to user query 156. For example, the report may include an introduction that summarizes one or more issues or instructions of the user, descriptions of one or more possible root causes or explanations, and a conclusion that suggests one or more resolutions or approaches to the issues or instructions of the user. The report may also include a natural language summary customized based on a viewpoint based on a profile of the user. The applications can use the output report to generate three-dimensional visualizations on user interface 150 with interactive elements related to a deterministic result of a schema. For example, user interface 150 may use an output of language processing system 104 to enable executing code/instructions (e.g., transmissions, control system commands, etc.), drilling into traceability, activating application features, and the like.

Schema code 136 may refer to source code, machine code, or any computer-readable instructions for carrying out an action of a schema (e.g. instructions assigned to one action of a deterministic action sequence defined by a schema). A schema may include a high-level list of actions or subtasks, while schema code includes the actual computer code that, when executed, performs the respective action(s) or subtask(s). In some aspects, schema code 136 may invoke various tools available through tools interface 128 to carry out an action of a schema. In some aspects, schema code 136 may invoke one or more helper function(s) 144 that may also be stored in data store 112. For example, a schema may include an action to check whether a sensor reading of procedure subject 108 is above a target threshold. In this example, schema code 136 corresponding to this action may define a function call to one or more helper function(s) 144, invoking a tool provided by tools interface 128 to obtain the sensor reading and compare the sensor reading to a predefined target threshold. The function call may then return the result of the comparison. Tools interface 128 may provide functionality for schema execution engine 118 and orchestration engine 110 to interact with procedure subject 108. In some aspects, tools interface 128 may execute helper functions 144 to carry out various instructions or actions in schema(s) 132 or schema code 136. In some aspects, tools interface 128 may also submit queries to and receive responses from language processing system 104.

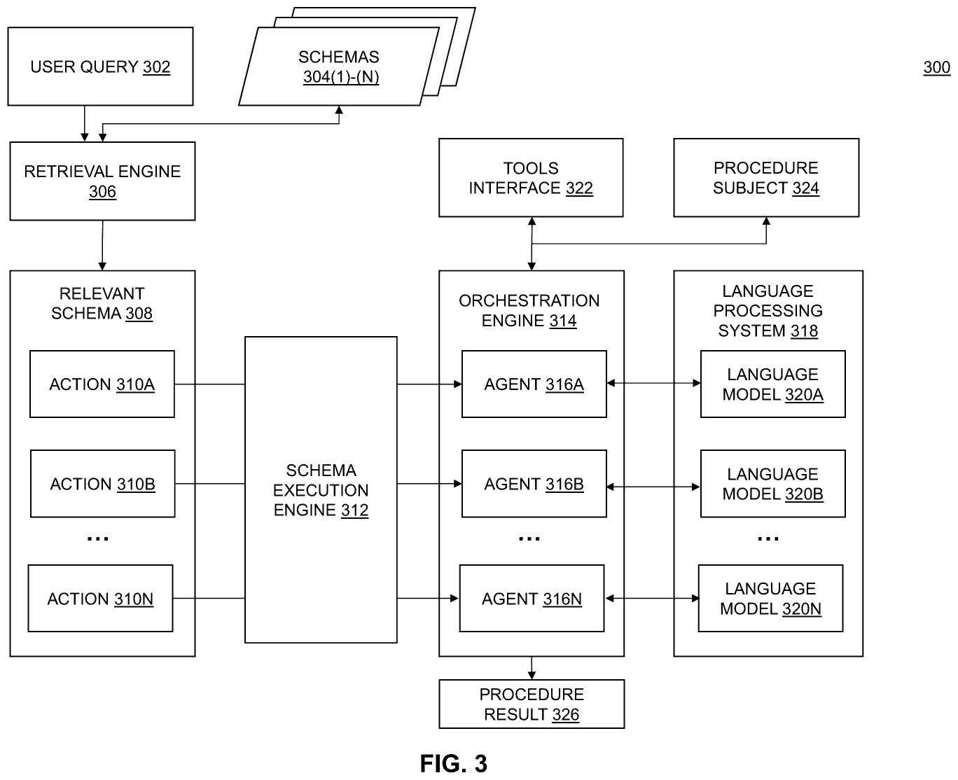

Schema execution engine 118 may execute schema(s) 132 and any associated schema code 136 to perform a procedure on procedure subject 108. In some aspects, schema execution engine 118 may execute schema(s) 132 in response to user query 156. Alternatively or additionally, schema execution engine 118 may execute schema(s) 132 in response to a query by procedure subject 108 (e.g. routine maintenance or detected malfunction). In some aspects, schema execution engine 118 may interface with orchestration engine 110, which may employ one or more agents 130A, 130B, and 130N (collectively, “agents 130”) to perform various tasks and functionalities on schema management platform 102, such as obtaining data, parsing natural language inputs, and transmitting data. An example orchestration engine 110 may be implemented as described in U.S. application Ser. No. 18/542,536 filed Dec. 15, 2023 and titled “ENTERPRISE GENERATIVE ARTIFICIAL INTELLIGENCE ARCHITECTURE,” now U.S. Pat. No. 12,111,859, the disclosure of which is incorporated by reference herein in its entirety. Orchestration engine 110 may interface with schema execution engine 118 and employ language models 148 to execute various schema(s) 132, as will be described in further detail hereafter with respect to FIG. 3.

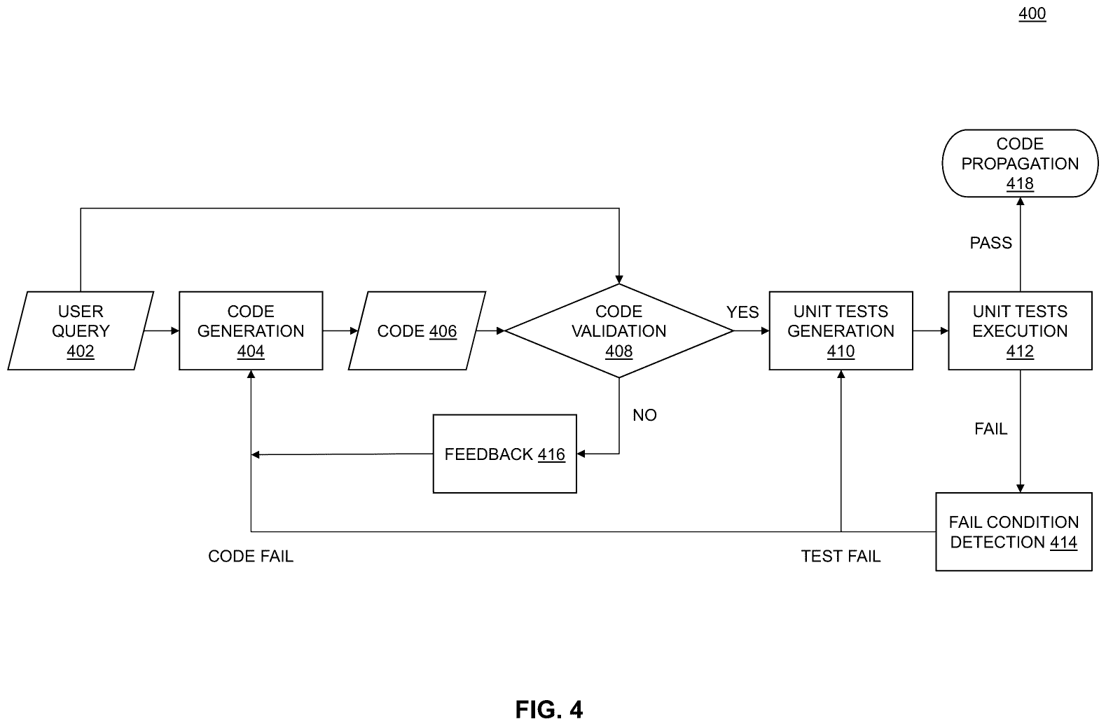

Unit test(s) 134 may refer to source code, machine code, or any computer-readable instructions for verifying the accuracy of associated code, such as schema code 136. In some aspects, validation engine 124 may employ unit test(s) 134 to programmatically validate that schema code 136 accurately performs the corresponding action or task outlined by the associated schema. In some aspects, schema code 136 and/or unit test(s) 134 may be predefined or pre-implemented by a subject matter expert. Alternatively or additionally, schema code 136 and/or unit test(s) 134 may be generated via code generation engine 116, the full process of which will be explained in further detail hereafter, particularly with respect to FIG. 4.

Generally, prompt(s) 138 may refer to unimodal or multimodal natural language instructions or computer code that is fed into a language processing system (e.g. language processing system 104). Prompt(s) 138 may include contexts, user instructions, system instructions, and/or other metadata for guiding language processing system 104 towards generating a desired output. Prompt(s) 138 may come in many different forms and have various different applications. For example, prompt(s) 138 may define functionality for generating system-created schemas, generating schema code (e.g. schema code 136), and generating unit tests (e.g. unit test(s) 134). Prompt template(s) 140 may define certain structures for prompt(s) 138 to follow before prompt(s) 138 are submitted to language processing system 104. Prompt template(s) 140 may leverage predefined configurations or optimizations for obtaining more accurate and higher quality responses by language processing system 104. For example, prompt template(s) 140 may provide additional context for a task, specific rules or guidelines to follow during inference, and predefined helper functions to reference (e.g. helper function(s) 144). Prompt template(s) 140 may also define how user queries (e.g. user query 156) are incorporated into prompt(s) 138. For example, a prompt template may include various placeholders where different portions of user query 156 may be inserted.

Subject matter data 146 may include information about a specialized technical context (e.g. a context related to procedure subject 108). For example, subject matter data 146 may include previously generated user-created schemas, system-created schemas, and technical documents such as user manuals, operating manuals, service manuals, instruction manuals, bulletins, and conversation data (e.g. transcripts of conversations between users, conversations between one or more users and language processing systems 104, etc.). Subject matter data 146 may also include information that is directly uploaded by a subject matter expert or user within a particular technical context.

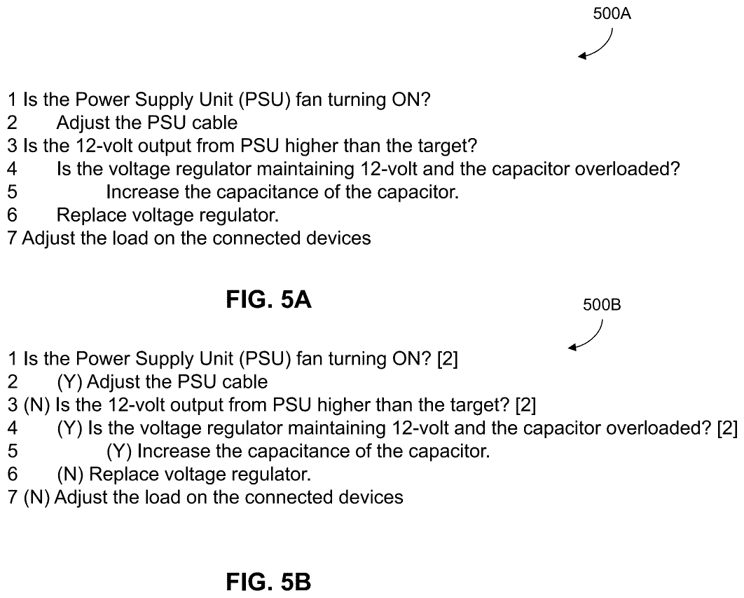

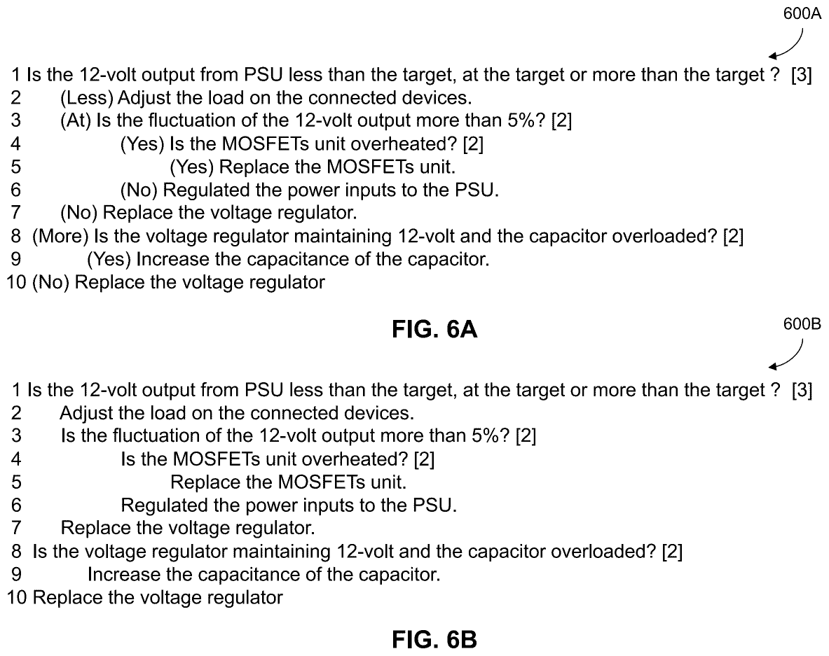

Retrieval engine 122 may retrieve structured or unstructured data within schema management platform 102. In some aspects, retrieval engine 122 may employ various search and retrieval methods to obtain records from data store 112. For example, retrieval engine 122 may first analyze a query (e.g. user query 156) to determine a relevant schema from among schema(s) 132 in data store 112. In some aspects, retrieval engine 122 may perform classification on user query 156 and/or extract search parameters from user query 156. For example, retrieval engine 122 may employ a different retrieval technique based on a specific classification result. In unstructured text retrieval contexts, retrieval engine 122 may employ techniques including, but not limited to, Boolean search techniques via TF-IDF scoring, semantic search, hybrid retrieval techniques, and cross-encoder re-ranking strategies. For structured text retrieval contexts, retrieval engine 122 may employ various techniques including, but not limited to, field-specific matching, numerical range queries, faceted search, and fuzzy search. Ultimately, the techniques relied upon by retrieval engine 122 may depend on how records in data store 112 are formatted. With respect to schema(s) 132, a few possible implementations are contemplated and discussed hereafter in FIGS. 5A-6B; however, those implementations are not meant to be limiting.

In some aspects, schema management platform 102 may store, in data store 112, embedding(s) 142 for schema(s) 132 to aid in retrieval. Embedding(s) 142 may serve as condensed, numerical representations that can help quickly differentiate different text data records, such as schema(s) 132. For example, retrieval engine 122, when tasked with identifying a relevant schema, may perform a similarity search (e.g. k-nearest neighbors, approximate nearest neighbors, locality-sensitive hashing, etc.) over embedding(s) 142 to identify the most similar schemas that fit a procedure description provided in user query 156.

Validation engine 124 may perform various validation functionalities across schema management platform 102. In some aspects, validation engine 124 may validate a determinism of a generated schema. “Determinism” as used herein may refer to a property where the same outcome is always reached given the same input conditions. In other words, each input or action in a deterministic environment will produce the same nonrandom, traceable outcome. With respect to schema(s) 132, a generated schema may not observe determinism if decision conditions contain overlapping cases. This may lead to different schema outcomes from the same input conditions. For example, a schema action may ask whether a sensor reading is “more than 10” or “less than 12” and provide two corresponding actions to take, “action A” and “action B” respectively. In this example, the schema may not have one defined action to take in the case when the sensor reading has a value of “11,” which may cause schema execution engine 118 to execute one or both of “action A” and “action B.” As discussed previously, determinism may be significant in the context of transformer-based multimodal models (e.g. language models 148), since these models tend to be non-deterministic (i.e., not observing determinism), which can create factually incorrect, imprecise and potentially detrimental outputs, especially in real-world contexts.

Alternatively or additionally, validation engine 124 may validate the completeness of an action or decision of an action sequence defined by a schema. “Completeness” may involve exhaustively covering all possible input conditions for a schema decision. In some cases, a schema action may observe determinism but not be complete. For example, a schema action may ask whether a sensor reading is “less than 10” or “greater than 10,” and provide two corresponding actions to take, “action C” and “action D” respectively. However, this example may leave out the case when the sensor reading is “exactly 10.” As such, the schema may always recommend the same action and observe determinism (e.g. “action C” when “less than 10,” “action D” when “greater than 10,” and nothing/error when “exactly 10”). Thus, checking for completeness may be important as well to validate a generated schema and ensure that all possible input conditions are covered. Validation engine 124 may employ various techniques to validate determinism and/or completeness of schemas, including but not limited to, subset construction, binary decision diagrams, and partition refinement.

Additionally, validation engine 124 may validate schema code 136 generated by code generation engine 116. In some aspects, validation engine 124 may first employ language processing system 104 directly via one or more prompt(s) 138 to semantically validate whether generated schema code 136 performs the action specified in the corresponding schema. In some aspects, validation engine 124 may provide feedback regarding why specifically schema code 136 may not perform the specified action. In some aspects, validation engine 124 may also employ language processing system 104 to generate unit test(s) 134 and programmatically validate whether a generated instruction or schema code performs the specified action. In some aspects, validation engine 124 may also employ language processing system 104 to detect a unit test fail condition that identifies a source of a failed unit test (e.g. a problem with the test itself or a problem with the generated schema code).

Mining engine 126 may automatically analyze subject matter data 146 and various inputs from client device 106 to recommend schemas to generate. For example, a user may engage in conversations with language processing system 104 describing how to perform an enterprise-specific procedure for which schema management platform 102 does not have a schema. These conversations may be stored as conversation data in subject matter data 146. Mining engine 126 may, alone or in combination with other components of example schema management platform architecture 100 (e.g. language processing system 104), determine that a schema may be generated from the conversation data. As another example, two machines may have similar components and various overlapping servicing procedures. Mining engine 126 may recommend generating a schema from a schema that exists for one of the machines and an operation manual for the other machine.

Propagation engine 120 may interface with various additional components in schema management platform 102 to propagate relevant schema changes across schema(s) 132. In some aspects, schema generation engine 114 may update a schema based on user query 156 or other input detected from user input engine 152 or subject matter data 146. In such aspects, propagation engine 120 may propagate the same or a similar schema update to all related and similar schemas in data store 112. For example, schema execution engine 118 may, based on a schema, instruct a user to adjust a machine setting from “10” to “20” as a first step in solving an issue that procedure subject 108 is experiencing. However, the user may, for whatever reason, adjust the machine setting to “25” and discover that procedure subject 108 is no longer experiencing the issue. As a result, the user may inform schema execution engine 118, after which schema management platform 102 may update the associated schema within schema(s) 132 to include the “25” value. Additionally or alternatively, procedure subject 108 may inform schema execution engine 118 directly, after which schema management platform 102 may similarly update the associated schema within schema(s) 132 to include the “25” value.

In some aspects, propagation engine 120 may also propagate validated code for a schema action or subtask generated by language processing system 104. For example, propagation engine 120 may receive code for a schema action or subtask generated by code generation engine 116. The generated code may be validated by validation engine 124 following similar processes as described above. Propagation engine 120 may then propagate the generated code to schema code 136 stored in data store 112. Propagation engine 120 may also assign the generated code to a specific action of the corresponding schema (e.g. using a mapping table, metadata, etc.). As such, any system looking to execute that schema may leverage the propagated schema code when executing the associated schema action (e.g. as opposed to invoking language processing system 104).

In some aspects, propagation engine 120 may also propagate instructions that were generated for an action of a first schema to one or more other schemas. For example, propagation engine 120 may determine that a generated code is relevant to a different action within an action sequence of a second schema. This determination may be performed using various methods, including but not limited to similarity analysis, semantic search, and language processing system 104. Upon determining the different action to which the generated code could be relevant, propagation engine 120 may then assign the generated code (that was generated for the action of the first schema) to the action of this second schema.

Client device 106 may be one or more of a desktop computer, a laptop computer, a tablet, a mobile phone, a smart appliance such as a smart television, and/or a wearable apparatus of the user that includes a computing device (e.g. a smartwatch, smart glasses, or a virtual or augmented reality computing device). Additional and/or alternative client devices may be contemplated. Client device 106 may include a corresponding user interface 150, user input engine 152, application engine 154, user query 156, and client memory 158.

User interface 150 may be configured to render content including unimodal responses, multimodal responses, or other content for audible or visual presentation to a user of client device 106 using one or more user interface output devices. For example, client device 106 may include a display or projector that enables content to be provided for visual presentation to a user via client device 106. Alternatively or additionally, client device 106 may include one or more speakers that enable content to be provided for audible presentation to a user via client device 106.

User input engine 152 may detect user input provided by a user of client device 106 using one or more user interface input devices. For example, client device 106 may include one or more microphones that capture audio data, such as audio data corresponding to spoken utterances of the user or other sounds in an environment surrounding client device 106. Alternatively or additionally, client device 106 may include one or more vision components (e.g. a camera) that may capture vision data corresponding to images and/or movements (e.g. gestures) detected in a field of view of one or more of the vision components. Alternatively or additionally, client device 106 may include one or more touch sensitive components including, but not limited to, a keyboard and mouse, a stylus, a touch screen, a touch panel, and physical buttons configured to capture signals corresponding to touch input directed towards client device 106.

Application engine 154 may execute one or more software applications on client device 106. In some aspects, application engine 154 may submit a natural language query (e.g. user query 156) to schema management platform 102. Application engine 154 may then receive unimodal, multimodal, or other responses from schema management platform 102 in response to a natural language query, which may then be rendered onto user interface 150 (e.g. audibly and/or visually). Application engine 154 may execute one or more software applications that are separate from an operating system of the client device 106 or may alternatively be implemented directly by the operating system of client device 106. For example, the application engine 154 may execute one or more software applications via a web browser or assistant.

User query 156 may represent an input provided by a user of client device 106 and may be detected via user input engine 152. For example, user query 156 may include a request from a user to diagnose a particular machine in an industrial context. Alternatively or additionally, user query 156 may include a request to generate a schema or a request to generate code for a specific action or subtask of a schema. User query 156 may also include various inputs from a subject matter expert. In some aspects, user query 156 may be a typed query that is typed via a physical or virtual keyboard, a suggested query that is selected via a touch screen or a mouse of client device 106, a spoken voice query that is detected via a microphone of client device 106 (or directed to an voice assistant running at client device 106), or an image or video query that is based on vision data captured by a vision component of client device 106.

In some aspects, user query 156 may be converted to a natural language based input or a multimodal input to be submitted to schema management platform 102. Alternatively or in addition, user query 156 may be sourced via image processing techniques utilizing, for example, object detection models, captioning models, or the like. In some aspects, user query 156 may be a prompt for content that is formulated based on user input provided by a user of client device 106 and detected via user input engine 152. For example, the prompt can be a typed prompt that is typed via a physical or virtual keyboard, a suggested prompt that is selected via a touch screen or a mouse of client device 106, a spoken prompt that is detected via a microphone of client device 106, or an image or video prompt based on data captured by a vision component of client device 106.

Client memory 158 may include a data store containing data about a user of client device 106 or about client device 106 itself. In some aspects, client memory 158 may store one or more queries (e.g. user query 156) made by a user of client device 106. Client memory 158 may also store a context of client device 106. As just one example, client memory 158 may store conversation data by a user. Client memory 158 may also store user interaction data about current or recent interactions between a user or multiple users and client device 106. In some aspects, client memory 158 may also store location data about current or recent locations of client device 106 or a geographical region associated with a user of client device 106. Client memory 158 may also store user attribute data, user preference data, a user profile, or various configurations relating to client device 106 or a user of client device 106. In some aspects, the data stored in client memory 158 may be communicated partially or entirely to schema management platform 102 (e.g. to produce higher quality outputs).

In an example implementation, a generative artificial intelligence system that connects to one or more virtual metadata repositories across data stores, abstracts access to disparate data sources, and supports granular data access controls is maintained by the enterprise artificial intelligence system. The enterprise generative artificial intelligence framework can manage a virtual data lake with an enterprise catalogue that connect to a multiple data domains and industry specific domains. The orchestrator of the enterprise generative artificial intelligence framework is able to create embeddings for multiple data types across multiple industry verticals and knowledge domains, and even specific enterprise knowledge. Embedding of objects in data domains of the enterprise information system enable rapid identification and complex processing with relevance scoring as well as additional functionality to enforce access, privacy, and security protocols. In some implementations, the orchestrator module can employ a variety of embedding methodologies and techniques understood by one of ordinary skill in the art. In an example implementation, the orchestrator module can use a model driven architecture for the conceptual representation of enterprise and external data sets and optional data virtualization. For example, a model driven architecture can be as described in U.S. Pat. No. 10,817,530, issued Oct. 27, 2020 from application Ser. No. 15/028,340, with priority to Jan. 23, 2015, titled Systems, Methods, and Devices for an Enterprise Internet-of-Things Application Development Platform, by C3.ai, Inc. A type system of a model driven architecture can be used to embed objects of the data domains.

The model driven architecture handles compatibility for system objects (e.g., components, functionality, data, etc.) that can be used by the orchestrator to dynamically generate queries for conducting searches across a wide range of data domains (e.g., documents, tabular data, insights derived from AI applications, web content, or other data sources). The type system provides data accessibility, compatibility and operability with disparate systems and data. Specifically, the type system solves data operability across diversity of programming languages, inconsistent data structures, and incompatible software application programming interfaces. Type system provides data abstraction that defines extensible type models that enables new properties, relationships and functions to be added dynamically without requiring costly development cycles. The type system can used as a domain-specific language (DSL) within a platform used by developers, applications, or UIs to access data. The type system provides interact ability with data to perform processing, predictions, or analytics based on one or more type or function definitions within the type system. The orchestrator is a mechanism for implementing search functionality across a wide variety of data domains relative to existing query modules, which are typically limited with respect to their searchable data domains (e.g., web query modules are limited to web content, file system query modules are limited to searches of file system, and so on).

Type definitions can be a canonical type declared in metadata using syntax similar to that used by types persisted in the relational or NoSQL data store. A canonical model in the type system is a model that is application agnostic (i.e., application independent), enabling all applications to communicate with each other in a common format. Unlike a standard type, canonical types are comprised of two parts, the canonical type definition and one or more transformation types. The canonical type definition defines the interface used for integration and the transformation type is responsible for transforming the canonical type to a corresponding type. Using the transformation types, the integration layer may transform a canonical type to the appropriate type.

FIG. 2 illustrates an example block diagram of a system 200 for generating a schema, according to some aspects. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 2, as will be understood by a person of ordinary skill in the art. System 200 shall be described with reference to FIG. 1. However, system 200 is not limited to those example aspects.

As shown in FIG. 2, system 200 may include user query 202, retrieval engine 204, schema generation engine 206, language processing system 208, output schema 210, validation engine 212, schemas 214(1)-(N), operating manuals 216(1)-(N), conversations 218(1)-(N), and mining engine 220, and schema execution engine 222. In some aspects, user query 202 may be an example of user query 156 (of FIG. 1). Retrieval engine 204 may be an example of retrieval engine 122. Schema generation engine 206 may be an example of schema generation engine 114. Language processing system 208 may be an example of language processing system 104. Validation engine 212 may be an example of validation engine 124. Schemas 214(1)-(N) and output schema 210 may be examples of schema(s) 132. Operating manuals 216(1)-(N) and conversations 218(1)-(N) may be examples of subject matter data 146. Mining engine may be an example of mining engine 126. Schema execution engine 222 may be an example of schema execution engine 118.

Similar to the discussion above, user query 202 may represent an input provided by a user of client device 106 and may be detected via user input engine 152. User query 202 may include a request from a user to diagnose a particular machine in an industrial context. Alternatively or additionally, user query 202 may specifically include a request to generate a schema for a procedure.

Based on user query 202, retrieval engine 204 may retrieve structured or unstructured data within schema management platform 102. In some aspects, retrieval engine 122 may employ various search and retrieval methods to obtain relevant records from data store 112, including schemas 214(1)-(N), operating manuals 216(1)-(N), and/or conversations 218(1)-(N). For example, retrieval engine 204 may determine a reference schema from among schemas 214(1)-(N) based on user query 202. In some aspects, a reference schema may be a schema that performs a similar or identical procedure for another procedure subject that is similar to procedure subject 108 (e.g. a drill press and a milling machine).

In some aspects, system 200 may calculate similarities between schemas 214(1)-(N) and user query 202 to determine a reference schema. Retrieval engine 204 may determine a reference schema to be a schema in schemas 214(1)-(N) with a similarity that is above a threshold. In such aspects, retrieval engine 204 may deem that this reference schema is a relevant schema that is relevant to (e.g. can successfully solve) the problem specified in user query 202. Retrieval engine 204 may then choose to forward this relevant schema to schema execution engine 222 for execution. This process is described in further detail below with respect to FIG. 3. If the similarity between schemas 214(1)-(N) and user query 202 are all below a threshold however, retrieval engine 204 may determine that schemas 214(1)-(N) do not contain a schema that can solve the problem specified in user query 202. As such, retrieval engine 204 may identify a reference schema from among schemas 214(1)-(N) that is the most helpful (e.g. highest similarity) for generating a schema that can solve the problem specified in user query 202. Retrieval engine 204 may then forward this reference schema to schema generation engine 206.

For example, user query 202 may specify an intent regarding diagnosing an issue with a first machine. Retrieval engine 204 may determine that schemas 214(1)-(N) do not contain a schema that is applicable to the first machine (e.g. similarities between user query and schemas 214(1)-(N) are all below a threshold). However, retrieval engine 204 may determine that operating manuals 216(1)-(N) contain an operating manual for the first machine (e.g. “manual A”) and an operating manual for a second machine (e.g. “manual B”) that is generally similar to the first machine (e.g. through techniques such as semantic or vector search). Schemas 214(1)-(N) may also contain a schema (e.g. “schema X”) pertaining to diagnosing and/or solving issues with the second machine. As such, retrieval engine 204 may determine “schema X” as a reference schema based on user query 202. Retrieval engine 204 may also determine that “manual A” and “manual B” are relevant records for user query 202.

Schema generation engine 206 may then receive any relevant records obtained by retrieval engine 204 to generate a schema (e.g. a system-created schema). In some aspects, schema generation engine 206 may formulate prompt(s) 138 to generate a system-created schema. In some aspects, schema generation engine 206 may wrap user query 202 and any relevant records (e.g. reference schema(s), relevant operating manual(s), relevant conversation(s), etc.) inside a prompt template (e.g. prompt template(s) 140). For example, schema generation engine 206 may formulate a prompt that leverages a schema defining a first process for diagnosing and/or solving issues with a first machine, a corresponding operating manual for the first machine, and an operating manual for a second machine to generate a schema defining a second process for diagnosing and/or solving similar issues for the second machine.

Alternatively or additionally, schema generation engine 206 may receive relevant records from mining engine 220 to generate a schema. For example, mining engine 220 may analyze conversations 218(1)-(N) and determine that a user has questions regarding how to perform a first process in an organization (e.g. “process C”) that does not have an associated schema in schemas 214(1)-(N). Mining engine 220, alone or in combination with other systems (e.g. schema generation engine 206 or language processing system 208) may then determine that a second process (“e.g. process D”) is similar to “process C.” This determination may be made, for example, by formulating an initial prompt and querying language processing system 208. Alternatively or additionally, this determination may be made based on a similarity or semantic comparison between the language used in respective conversations 218(1)-(N) and/or other subject matter data 146 (e.g. vector embedding representations).

In some aspects, schema generation engine 206 may ask a user (e.g. a subject matter expert) a series of questions to obtain subject matter data 146 about a procedure. Schema generation engine 206 may then formulate a prompt using subject matter data 146 from the user. Subject matter data 146 may not be limited to schemas 214(1)-(N), operating manuals 216(1)-(N), and conversations 218(1)-(N). Schema generation engine 206 may receive additional information, such as but not limited to flowcharts depicting decision flows, flowcharts depicting decision flows with multiple options, and flowcharts with conditional branching flows.

Schema generation engine 206, upon formulating a prompt, may query language processing system 208 to generate a corresponding schema—output schema 210. Output schema 210 may be an initial output schema defining an initial action sequence for performing a procedure specified by user query 202. In some aspects, language processing system 208 may employ one or more language models (e.g. language models 148 of FIG. 1) to interpret a prompt provided by schema generation engine 206 and construct a response. In constructing a response, language processing system 208 may employ various techniques including, but not limited to multi-head self-attention mechanisms, positional encoding, layer normalization, masked autoregressive decoding nucleus sampling, softmax token distribution computation, and key-value cache optimization. In some aspects, language processing system 208 may first generate an intermediate output rather than directly generating output schema 210. For example, language processing system 208 may construct a response containing a flowchart or state diagram according to a first format. Schema generation engine 206 or schema management platform 102 may then convert the response constructed by language processing system 208 into output schema 210.

In some aspects, output schema 210 may itself also represent an intermediary result in the schema generation process. For example, output schema 210 may not define a fully deterministic sequence of actions for performing a procedure (whereas schemas 214(1)-(N) may all be fully deterministic). As such, validation engine 212 may receive output schema 210 and verify whether an initial action sequence defined by output schema 210 is fully deterministic. Alternatively or additionally, validation engine 212 may validate the completeness of an initial action sequence defined by output schema 210. Validation engine 212 may employ various techniques to validate determinism and/or completeness of output schema 210, including but not limited to, subset construction, binary decision diagrams, and partition refinement. Upon validating these properties, system 200 may generate a final output schema that defines a deterministic action sequence for performing the procedure specified by user query 202. System 200 may then add the validated final output schema to schemas 214(1)-(N) for future use.

FIG. 3 illustrates an example block diagram of a system 300 for executing a schema, according to some aspects. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art. System 300 shall be described with reference to FIG. 1. However, system 300 is not limited to those example aspects.

As shown in FIG. 3, system 300 may include user query 302, schemas 304(1)-(N), retrieval engine 306, relevant schema 308, schema execution engine 312, orchestration engine 314, language processing system 318, tools interface 322, procedure subject 324, and procedure result 326. Relevant schema 308 may include action 310A, action 310B, and action 310N (collectively, “actions 310”). Orchestration engine 314 may include agent 316A, agent 316B, and agent 316N (collectively, “agents 316”). Language processing system 318 may include language model 320A, language model 320B, and language model 320N (collectively, “language models 320”). In some aspects, user query 302 may be an example of user query 156 (of FIG. 1). Schemas 304(1)-(N) and relevant schema 308 may be examples of schema(s) 132. Retrieval engine 306 may be an example of retrieval engine 122. Schema execution engine 312 may be an example of schema execution engine 118. Orchestration engine 314 may be an example of orchestration engine 110. Agents 316 may be examples of agents 130. Language processing system 318 may be an example of language processing system 104. Language models 320 may be examples of language models 148. Tools interface 322 may be an example of tools interface 128. Procedure subject 324 may be an example of procedure subject 108.

Similar to the discussion above, user query 302 may represent an input provided by a user of client device 106 and may be detected via user input engine 152. User query 302 may include a request from a user to diagnose a particular machine in an industrial context. Alternatively or additionally, user query 156 may simply include any request by a user or system looking to perform a procedure on procedure subject 324. User query 156 may also include various inputs by a subject matter expert, user, or system before, during, or after the schema execution process.

Based on user query 202, retrieval engine 306 may determine relevant schema 308 from among schemas 304(1)-(N). For example, relevant schema 308 may be a schema that performs a similar or identical procedure requested or described in user query 302 (e.g. issue diagnosis for a machine). Retrieval engine 306 may determine relevant schema 308, for example, through similarity or semantic search over schemas 304(1)-(N) and returning the result with the highest similarity score to user query 302. Retrieval engine 306 may also check whether the similarity score is greater than a similarity threshold. In some aspects, relevant schema 308 may correspond to output schema 210 generated by schema generation system 200 when user query 302 is the same as or similar to user query 202.

Relevant schema 308 may include actions 310 that outline the steps required for executing relevant schema 308 (e.g. a deterministic action sequence). Schema execution engine 312 may then receive relevant schema 308 and employ orchestration engine 314 to execute actions 310. In some aspects, orchestration engine 314 may assign or allocate one or more agents (e.g. agent 316A) to execute each action (e.g. action 310A) in relevant schema 308. Each agent may also communicate with one or more language models (e.g. language model 320A) and/or tools interface 322 to execute or carry out its assigned action. “Executing a schema” may refer to tangibly carrying out the decisions or actions in a schema on a procedure subject (e.g. procedure subject 324, a physical machine, an enterprise system, etc.).

In some aspects, agents 316 may interface with language processing system 318 and tools interface 322 to communicate with a user to determine a physical status of procedure subject 324 (e.g. through a chatbot environment). In some aspects, agents 316 may interface with tools interface 322 to execute predefined schema code (e.g. schema code 136 and/or helper function(s) 144) to carry out the assigned schema action. Alternatively or additionally, agents 316 may interface with language processing system 318 to perform a chain of complex calculations or observations to obtain a schema decision (e.g. through environment sensors such as a camera or a microphone and/or using helper function(s) 144). After agents 316 obtain their respective schema action decisions, orchestration engine 314 may reconcile the schema action decisions (e.g. by traversing a decision flow of relevant schema 308 with the obtained schema action decisions) to obtain procedure result 326. For example, procedure result 326 may include a properly diagnosed or repaired machine resulting from relevant schema 308. In some aspects, procedure result 326 may represent the completion of the procedure specified in user query 302.

In some aspects, a procedure result 326 may reflect a different outcome than the outcome depicted by relevant schema 308. For example, system 300 may instruct a separate system (e.g. “system A”), based on relevant schema 308, to adjust a setting of procedure subject 324 to a first value to solve an issue procedure subject 324 is experiencing. However, system 300 may receive data from “system A” or procedure subject 324 indicating that the setting has been adjusted to a second, different value. System 300 may also discover, based on the data, that procedure subject 324 no longer experiences the issue. As such, this may result in a procedure result 326 that is different from the action or result defined in relevant schema 308. In some aspects, this unexpected procedure result 326 may trigger system 300 to update relevant schema 308 to include the second value as a diagnosis option. Alternatively or additionally, a user may inform system 300 that procedure subject 324 no longer experiences an issue after adjusting the setting to the second value, which may also trigger system 300 to update relevant schema 308.

FIG. 4 illustrates an example process flow diagram of a process 400 for generating code for a schema, according to some aspects. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art. Process 400 shall be described with reference to FIG. 1. However, process 400 is not limited to those example aspects.

As shown in FIG. 4, process 400 may involve user query 402, code generation 404, code 406, code validation 408, unit tests generation 410, unit tests execution 412, fail condition detection 414, feedback 416, and code propagation 418. In some aspects, user query 402 may be an example of user query 156 (of FIG. 1). Code 406 may be an example of schema code 136.

Similar to the discussion above, user query 402 may represent an input provided by a user of client device 106 and may be detected via user input engine 152. User query 402 may include a request from a user to generate code for a specific action or subtask of a schema. In some aspects, user query 402 may be generated by and forwarded from schema management platform 102. In some aspects, the request to generate code may be inferred from user query 402 when a schema needed for responding to user query 402 has insufficient or no code associated with one or more actions or subtasks of the schema.

Code generation 404 may involve generating code 406 (e.g. executable schema code) via code generation engine 116. In some aspects, code generation engine 116 may interface with language processing system 104 to generate code 406. For example, code generation engine 116 may first construct a prompt (e.g. prompt(s) 138) using prompt template(s) 140, available helper functions (e.g. helper function(s) 144), and user query 402. Code generation engine 116 may then query language processing system 104 using the constructed prompt to obtain code 406.

Upon obtaining code 406, system 400 may perform code validation 408. In some aspects, code validation 408 may involve semantically validating, via language processing system 104, that code 406 performs the specified schema action or subtask in user query 402. For example, validation engine 124 may construct another prompt using prompt template(s) 140, available helper functions (e.g. helper function(s) 144), and user query 402. Validation engine 124 may then query language processing system 104 using the constructed prompt to obtain a validation result. For example, validation engine 124 may receive a positive validation result of “Yes” from language processing system 104 indicating that code 406 does indeed perform the specified schema action or subtask. Inversely, validation engine 124 may receive a negative result of “No” from language processing system 104 indicating that code 406 does not perform the specified schema action or subtask.

In some aspects, validation engine 124 (e.g. in addition to a “No” result) may receive feedback 416 explaining why code 406 does not perform the specified schema action or subtask. For example, feedback 416 may simply identify a specific line or function call that is incorrect within code 406. Code generation 404 may receive feedback 416 and then regenerate code 406 by querying language processing system 104 and/or including feedback 416 inside a constructed prompt.

In some aspects, unit tests generation 410 may include generating unit tests for additional validation of code 406. For example, validation engine 124, in response to a “Yes” result, may construct a prompt for language processing system 104 to generate one or more unit tests (e.g. unit test(s) 134). Unit test(s) 134 may serve as additional programmatic validation for code 406 to verify accuracy and robustness of code 406 generated by language processing system 104. In one technical improvement over current processing systems, including unit tests generation 410 for code validation directly improves the robustness and security of the resulting generated code and the systems that will execute such code. These extra validation measures add additional security to the associated computing systems and ensure that any schemas that are executed on those systems are error and bug free. These features save the computational resources and overhead required to fix any problems or system malfunctions caused by uncaught errors.

Unit tests execution 412 may include executing the unit tests generated during unit tests generation 410. In some aspects, validation engine 124 may leverage tools interface 128 and/or helper function(s) 144 to execute the generated unit tests and obtain one or more unit test results. For example, validation engine 124 may obtain a positive unit test “Pass” result from executing the one or more unit tests. In some aspects, system 400 may apply code propagation 418 in response to a “Pass” result from one or more unit tests. Code propagation 418 may involve propagating the validated code (e.g. code 406) to schema code 136. For example, propagation engine 120 may propagate the generated code to schema code 136 stored in data store 112. Propagation engine 120 may also assign the generated code to a specific action of the corresponding schema. As such, any system looking to execute that schema may leverage the propagated schema code when executing the associated schema action.

Validation engine 124 may also obtain a negative unit test “Fail” result from executing the one or more unit tests. Fail condition detection 414 may include detecting a root cause of one or more failed unit tests. For example, validation engine 124, in response to a “Fail” result, may construct a prompt for language processing system 104 to determine whether the one or more generated unit tests are incorrect (e.g. “Test Fail” case) or whether code 406 itself is incorrect (e.g. “Code Fail” case). In the “Code Fail” case, code generation engine 116 may regenerate code 406 in code generation 404. In some aspects, code generation engine 116 may construct a prompt to language processing system 104 that includes the one or more failed unit tests. In the “Test Fail” case, validation engine 124 may regenerate one or more unit tests in unit tests generation 410 to replace the incorrect unit test. In some aspects, upon regenerating code 406 or the one or more failed unit tests, the code generation process continues until a unit test “Pass” result is obtained.

In some aspects, code propagation 418 may also involve propagating code 406 to one or more other schemas that were not included in user query 402. For example, propagation engine 120 may determine that code 406 is relevant to a different action within an action sequence of a different second schema. This determination may be performed using various methods, including but not limited to similarity analysis, semantic search, and language processing system 104. Upon determining the different action to which code 406 could be relevant, propagation engine 120 may then assign the generated code (that was generated for the action specified in user query 402) to the action in the second schema.

FIG. 5A illustrates an example schema 500A in a first implementation, according to some aspects. Example schema 500A shall be described with reference to FIG. 1. However, schema 500A is not limited to those example aspects. In some aspects, schema 500A may define a process for troubleshooting a problem that an industrial machine (e.g. procedure subject 108) is facing. Schema 500A defines seven actions or steps, some or all of which may be followed to diagnose or solve a problem. Schema 500A also includes one or more decisions or requests for specific information (e.g. a sensor reading value of procedure subject 108). Example schema 500A may follow a structured text format, where each decision is in “Yes” or “No” format (alternatively, “True/False” or “1/0”). In such a format, indented schema actions immediately following a decision may represent the “Yes” case of an agent decision or action result. Inversely, an un-indented schema action may represent the “No” case of the previous decision, which may be at the same indentation level.

For example, schema management platform 102 may utilize schema 500A in response to a user query (e.g. user query 156) that reads, “Please diagnose the issue with industrial machine XX.” In some aspects, schema management platform 102 may possess schema code 136 for carrying out one or more actions in schema 500A directly. In such aspects, schema management platform 102 may obtain an agent decision or action result directly and efficiently without performing expensive inferences by language processing system 104.

In some aspects, for example when schema code 136 is not available, orchestration engine 110 may deconstruct a schema action to obtain an agent decision or action result. For example, orchestration engine 110 may first determine, for example via language processing system 104, that a first action includes a decision. In some aspects, orchestration engine 110 may determine whether an action includes a decision based on a presence of a question mark. For example, orchestration engine 110 may determine that the schema action, “Is the Power Supply Unit (PSU) fan turning ON?” includes a decision.

In some aspects, orchestration engine 110 may then determine that executing the action requires one or more information items (e.g. the PSU fan status) to obtain a decision result. Orchestration engine 110 may leverage agent 130A to obtain the information items from data store 112 or procedure subject 108 directly. To achieve this, orchestration engine 110 may employ, via agent 130A, any of one or more other agents (e.g. agent 130B and agent 130N), language processing system 104, retrieval engine 122, tools interface 128, or helper function(s) 144. For example, agent 130A may conduct a text conversation with agent 130B using language processing system 104 to obtain the information. Agent 130A may also invoke the relevant helper function(s) 144 directly to obtain each piece of information. In some aspects, agent 130A may also request for a user input. After, orchestration engine 110 may analyze the obtained information to determine the agent decision or action result.

Based on the agent decision or action result (e.g. the result of line one of schema 500A), schema execution engine 118 may proceed to the next corresponding action defined by schema 500A. Following the structured format previewed above, a schema execution engine 118 may proceed to line two of schema 500A if the result of line one is “Yes” (e.g. that the PSU fan is turning ON). Otherwise, if the result of line one is “No,” schema execution engine 118 may proceed to line three of schema 500A. After proceeding to line two, schema execution engine 118 may, for example, execute the action using the techniques described above to “Adjust the PSU cable.” For example, schema execution engine 118 may leverage one or more agents 130 to directly modify procedure subject 108 or to return instructions to the user to modify procedure subject 108. Because there are no further decisions or actions to take, schema execution engine 118 may terminate the schema execution process and provide the result of schema 500A.

In the “No” case, schema execution engine 118 may continue the schema execution process and execute the action defined on line three. Similarly, in the “Yes” case, schema execution engine 118 may proceed to line four, and in the “No” case, schema execution engine 118 may proceed to line seven. In either case, the schema process continues in a deterministic fashion until a final schema result is reached, at which point the schema result may be provided (e.g. to schema management platform 102 or client device 106).

Variations for implementing or representing schemas are contemplated. In some aspects, binary schema decisions may have values other than “Yes” or “No,” such as “A” and “B.” In some aspects, in addition to or as an alternative to binary schema decisions, schema decisions may have more than two possible results. For example, a decision may have three results, with a first result in a first range (e.g. “less than 10” or “1-10”), a second result in a second range (e.g. “equal to 10” or “11-20”), and a third result in a third range (e.g. “more than 10” or “21-30”).

FIGS. 5B and 6A illustrate example schemas 500B and 600A in a second implementation. Example schema 500B defines the same action sequence as example schema 500A. However, example schemas 500B and 600A may be represented in a generalizable format to include non-“Yes”/“No” binary schema decisions and schema decisions with more than two possible results. In some aspects, this may be accomplished by specifying the number of possible results alongside each schema decision. Additionally, the associated decision condition may be included alongside the associated decision result or action.

For example, line one of schema 500B specifies that there are “[2]” possible outcomes. Specifically, when looking to lines two and three of schema 500B, these two outcomes may be “Y” (e.g. “Yes”) and “N” (e.g. “No”) respectively. As depicted, schema 500B may define the same action sequence as schema 500A. However, it should be appreciated that the implementation illustrated by schema 500B may allow for different orderings of the “Yes” and “No” cases and may even be expanded to cover alternative binary decisions (e.g. “A” and “B).

Schema 600A illustrates an implementation that may include more than two possible results. For example, line one of schema 600A specifies that there are three (e.g. “[3]”) possible outcomes. Specifically, in schema 600A, these outcomes are “Less” (e.g. 12-volt output from PSU less than the target), “At” (e.g. 12-volt output from PSU at the target), and “More” (e.g. 12-volt output from PSU more than the target). Similar to the format with binary action decisions, an indented action may still represent one possible outcome of an action decision. However, rather than immediately un-indenting after listing a first possible outcome, further outcomes or actions may maintain the same indentation level until the last possible outcome is listed.

Following the same example above, the first outcome of the decision on line one of schema 600A—the “Less” case on line two—may receive a first level indentation (e.g. one indent). The second outcome—the “At” case on line three—may also receive a first level indentation. The last outcome—the “More” case on line eight—may be un-indented to the indentation level of the decision on line one (e.g. no indent). Lines three and four of schema 600A depict additional schema decisions that specify two (e.g. “[2]”) possible outcomes. As such, these actions/steps of schema 600A may be executed in a similar manner in line with the discussion above with respect to binary schema decisions.

FIG. 6B illustrates another example schema 600B in a third implementation. Example schema 600B defines the same action sequence as example schema 600A. However, example schema 600B may be represented as a condensed version of the format illustrated by 500B and 600A that does not include associated decision conditions alongside decision results or actions. In some aspects, example schema 600A may specify the number of possible results (e.g. “[2],” “[3],” etc.) of a schema decision. In some aspects, example schema 600A may follow a structured format that infers or predefines the order of possible results of a schema decision. In such a format, the decision conditions do not need to be repeated alongside each decision result or action. In one technical improvement over current processing systems, this omission may conserve memory resources needed to store or display these decision conditions, allowing for more memory-efficient processing and schema execution.

In an example implementation, a query can be received that identifies a target procedure in a particular context. The schema management system can determine, based on the query, a reference schema for the target procedure from among a stored schemas, where each schema of the plurality of stored schemas includes knowledge for performing a respective procedure in a respective context. An instruction prompt is generated based on the query and at least the reference schema, and a target context. The instruction prompt is processed by multimodal model. The multimodal model can employ one or more agents to action the instruction prompt. In some implementations, the agents can generate additional prompts for iterative processing with the multi-modal model. The multi-modal model outputs a workflow based on the instruction prompt, the workflow defining a deterministic action sequence for performing the target procedure.

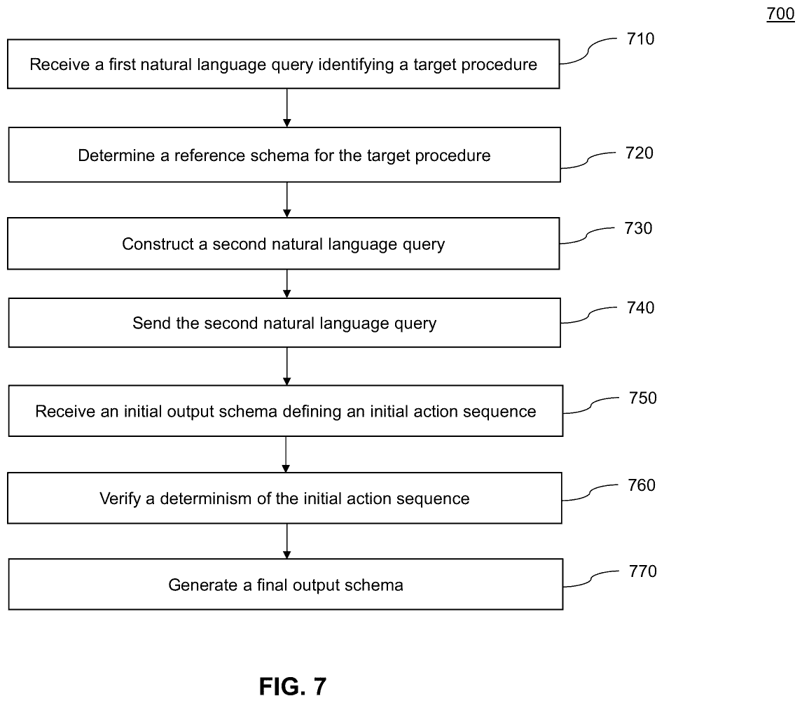

FIG. 7 illustrates an example flow diagram of a method 700 for generating a schema that can be carried out in line with the discussion above, according to some aspects. Method 700 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. Further, method 700 may not include all the steps illustrated.

Method 700 shall be described with reference to FIGS. 1 and 2. However, method 700 is not limited to those example aspects. One or more of the operations in the method depicted by FIG. 7 may be carried out by one or more entities, including, without limitation, schema management platform 102, language processing system 104, other server or cloud-based server processing systems and/or one or more entities operating on behalf of or in cooperation with these or other entities. One or more of the operations in the method depicted by FIG. 7 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

In 710, a first natural language query identifying a target procedure is received. For example, schema management platform 102 may receive user query 202 from client device 106 via user input engine 152. User query 202 may identify a target procedure in a particular context. For example, user query 202 may include a request from a user to diagnose a particular machine in an industrial context. As another example, user query 202 may specifically include a request to generate a schema for a target procedure in a particular context.

In some aspects, schema management platform 102 may receive a system-generated query from mining engine 220. For example, mining engine 220 may mine information relating to a particular context (e.g. schemas 214(1)-(N), operating manuals 216(1)-(N), and conversations 218(1)-(N), video data, etc.) to obtain a target procedure. Mining engine 220 may then construct a natural language query based on the mined information and forward the query to schema generation engine 206.

In 720, a reference schema for the target procedure is determined. For example, schema management platform 102 may employ retrieval engine 204 to retrieve a reference schema from data store 112 that performs a similar or identical procedure to the target procedure for a procedure subject that is similar to procedure subject 108. Retrieval engine 122 may employ various search and retrieval methods on records stored in data store 112 (e.g. schemas 214(1)-(N), operating manuals 216(1)-(N), and conversations 218(1)-(N)) using user query 202. In determining a reference schema, schema management platform 102 may calculate similarities between schemas 214(1)-(N) and user query 202. In some aspects, retrieval engine 204 may determine a reference schema to be a schema in schemas 214(1)-(N) with a similarity that is above a threshold. In other aspects, retrieval engine 204 may determine, when the similarity between schemas 214(1)-(N) and user query 202 are all below a threshold, a reference schema from among schemas 214(1)-(N) that is the most helpful (e.g. highest similarity) for generating a schema that can perform the target procedure identified by the first natural language query.

In 730, a second natural language query is constructed. For example, schema management platform 102 may construct a second natural language query. For example, schema management platform 102 may formulate a prompt to generate a system-created schema based on user query 202 (or query from mining engine 220) and a reference schema. In some aspects, schema management platform 102 may also include any other relevant records obtained by retrieval engine 204 (e.g. operating manuals, conversation data, subject matter expertise, etc.) within a prompt to aid the schema generation process.

In 740, the second natural language query is sent. For example, schema management platform 102, upon formulating a prompt for generating a schema based on the first natural language query, may transmit the constructed query to language processing system 208.

In 750, an initial output schema defining an initial action sequence is received. For example, schema management platform 102 may receive output schema 210 from language processing system 208. Output schema 210 may be an initial output schema defining an initial action sequence for performing the target procedure. Output schema 210 may initially not define a fully deterministic sequence of actions for performing a procedure. Output schema 210 may have been generated by language processing system 208 based on the second natural language query using various techniques including, but not limited to, multi-head self-attention mechanisms, positional encoding, layer normalization, masked autoregressive decoding nucleus sampling, softmax token distribution computation, and key-value cache optimization.

In 760, a determinism of the initial action sequence is verified. For example, schema management platform 102 may verify a determinism of the initial action sequence. For example, schema management platform 102 may employ validation engine 212 to verify whether an initial action sequence defined by output schema 210 is deterministic. In some aspects, validation engine 212 may also validate the completeness of the initial action sequence defined by output schema 210. Validation engine 212 may employ various techniques to validate determinism and/or completeness of output schema 210, including but not limited to, subset construction, binary decision diagrams, and partition refinement.

In 770, a final output schema is generated. For example, schema management platform 102, upon verifying the determinism of output schema 210, may generate a final output schema that defines a deterministic action sequence for performing the target procedure. This final output schema may provide a deterministic result when executed. In some aspects, schema management platform 102 may then execute the final output schema to obtain the deterministic result for the target procedure. In some aspects, schema management platform 102 may add final output schema to schemas 214(1)-(N) and write the final output schema to data store 112.

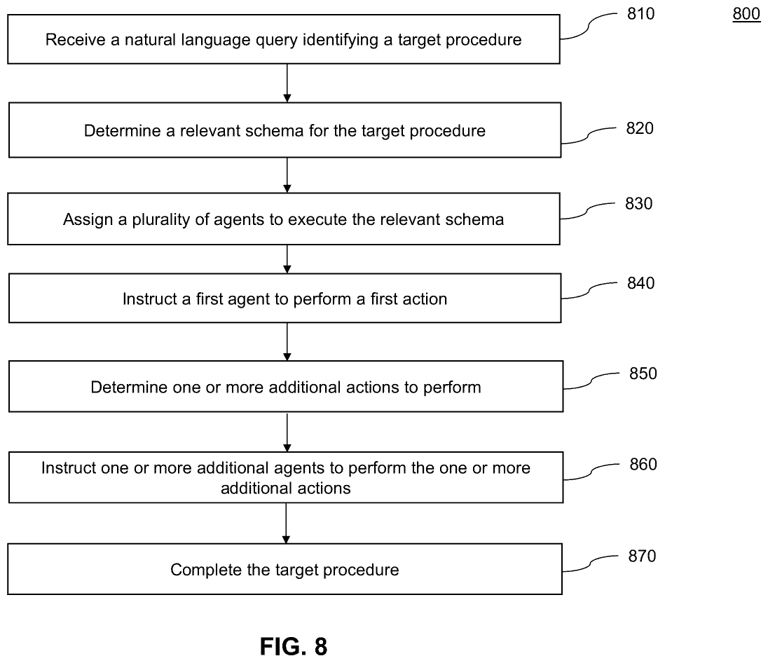

FIG. 8 illustrates an example flow diagram of a method 800 for executing a schema that may be carried out in line with the discussion above, according to some aspects. Method 800 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art. Further, method 800 may not include all the steps illustrated.

Method 800 shall be described with reference to FIGS. 1, 3, and 5. However, method 800 is not limited to those example aspects. One or more of the operations in the method depicted by FIG. 8 may be carried out by one or more entities, including, without limitation, schema management platform 102, language processing system 104, other server or cloud-based server processing systems and/or one or more entities operating on behalf of or in cooperation with these or other entities. One or more of the operations in the method depicted by FIG. 8 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

In 810, a natural language query identifying a target procedure is received. For example, schema management platform 102 may receive a natural language query identifying a target procedure. For example, schema management platform 102 may receive user query 302 from client device 106 via user input engine 152. User query 302 may include any request by a user or system looking to perform a procedure on procedure subject 324. For example, user query 302 may include a request from a user to diagnose a particular machine in an industrial context. The natural language query may also include various inputs by a subject matter expert, user, or system before, during, or after the schema execution process.

In 820, a relevant schema for the target procedure is determined. For example, schema management platform 102 may determine a relevant schema for the target procedure. For example, schema management platform 102 may obtain relevant schema 308 that performs a similar or identical procedure as the target procedure identified in the natural language query. Schema management platform 102 may employ retrieval engine 306 to perform similarity or semantic search over schemas 304(1)-(N) and return the result with the highest similar score to user query 302. Retrieval engine 306 may also check whether the similarity score is greater than a similarity threshold and determine the retrieved schema as a relevant schema to the target procedure (e.g. relevant schema 308). Relevant schema 308 may define a deterministic action sequence (e.g. actions 310) that outlines the steps required for performing the target procedure.

In 830, agents are assigned to execute the relevant schema. For example, schema management platform 102 may employ schema execution engine 312 and orchestration engine 314 to assign a plurality of agents 316 to execute relevant schema 308. In some aspects, an agent (e.g. agent 316A, agent 316B, etc.) may be assigned to an action (e.g. action 310A, action 310B, etc.) in relevant schema 308. Each agent may communicate with one or more language models (e.g. language model 320A) and/or tools interface 322 to execute or carry out its assigned action. For example, tools interface 322 may provide tools including but not limited to one or more additional language models, one or more machine learning models, one or more data models, one or more application platform interfaces, or one or more help functions. Agents 316 may also interface with language processing system 318 and tools interface 322 to communicate with a user to determine a physical status of procedure subject 324 (e.g. through a chatbot environment). In some aspects, agents 316 may interface with tools interface 322 to execute predefined schema code (e.g. schema code 136 and/or helper function(s) 144) to carry out an assigned schema action. Agents 316 may also interface with language processing system 318 to perform a chain of complex calculations or observations to obtain a schema decision (e.g. through environment sensors such as a camera or a microphone and/or using helper function(s) 144).

In 840, a first agent is instructed to perform a first action. For example, schema management platform 102 may instruct agent 316A to perform action 310A to obtain an agent decision. As described above, agent 316A, in obtaining an agent decision, may communicate with one or more language models (e.g. language model 320A) and/or tools interface 322. In some aspects, schema management platform 102 may start at an action that is not the first listed action in the schema. Referring to example schema 500A from FIG. 5, schema management platform 102 may start with the action associated with line three (“Is the 12-volt output from PSU higher than the target?”) instead of the action associated with line one (“Is the Power Supply Unit (PSU) fan turning ON?”) based on PSU fan status information provided in user query 302. It will be understood that the large language model may start at any appropriate position in a schema based on user query 302 or any other contextual information (e.g. relevant previous conversations between the users and/or between a user and language processing system 104, industrial machine settings, and documents such as such as operating manuals, user manuals, instruction manuals, and bulletins).

In 850, one or more additional actions to perform are determined. For example, schema management platform 102 may determine, based on an agent decision obtained by agent 316A, one or more actions (e.g. action 310B, action 310N, etc.) to perform. For example, schema management platform 102 may determine, based on an agent decision of “Yes” when executing line 1 of example schema 500A, an additional action specified by line 2 of example schema 500A (e.g. “Adjust the PSU cable”).

In 860, one or more additional agents are instructed to perform the one or more additional actions. For example, schema management platform 102 may instruct one or more additional agents to perform the one or more additional actions. For example, schema management platform 102 may instruct agent 316B to perform action 310B to obtain a final schema result (e.g. procedure result 326). For example, schema management platform 102 may instruct agent 316B to execute line 2 of example schema 500A—“Adjust the PSU cable.” Executing line 2 may involve invoking an associated schema code 136 via tools interface 322. In some aspects, procedure result 326 may reflect a different outcome than the outcome depicted by relevant schema 308. For example, schema management platform 102 may instruct a system (e.g. “system A”), based on relevant schema 308, to adjust a setting of procedure subject 324 to a first value to solve an issue procedure subject 324 is experiencing. However, schema management platform 102 may receive data from “system A” or procedure subject 324 indicating that the setting has been adjusted to a second, different value. From this, schema management platform 102 may discover, based on the data, that procedure subject 324 no longer experiences the issue. In some aspects, this unexpected procedure result 326 may trigger schema management platform 102 to update relevant schema 308 to include the second value as a diagnosis option or action.

In 870, the target procedure is completed. For example, schema management platform 102 may complete the target procedure. For example, schema management platform 102 may obtain procedure result 326 from executing relevant schema 308 on procedure subject 324. Procedure result 326 may include a properly diagnosed or repaired machine resulting from relevant schema 308. In some aspects, procedure result 326 may represent the completion of the procedure specified by user query 302.

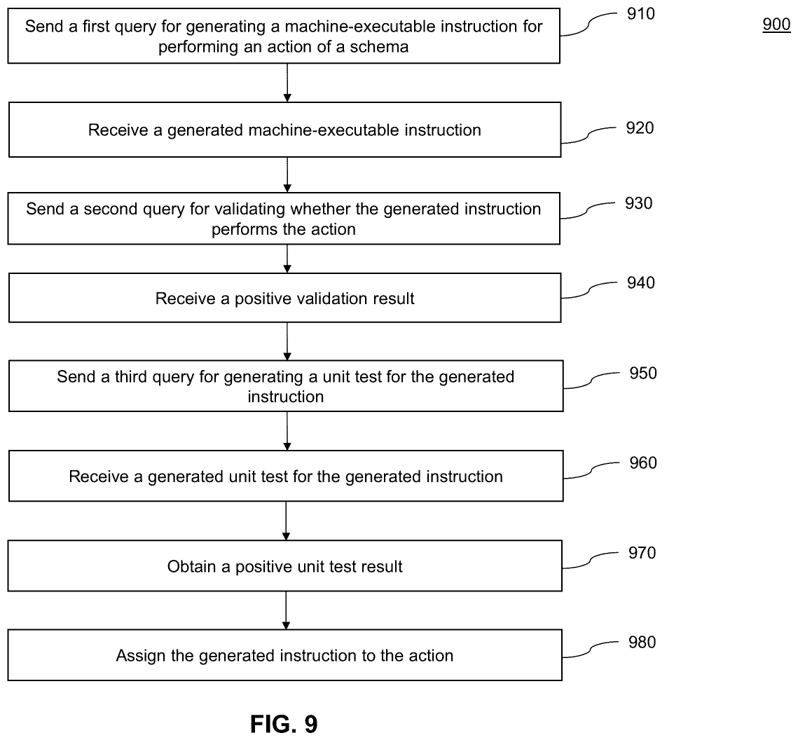

FIG. 9 illustrates an example flow diagram of a method 900 for generating code for a schema that may be carried out in line with the discussion above, according to some aspects. Method 900 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art. Further, method 900 may not include all the steps illustrated.

Method 900 shall be described with reference to FIGS. 1 and 4. However, method 900 is not limited to those example aspects. One or more of the operations in the method depicted by FIG. 9 may be carried out by one or more entities, including, without limitation, schema management platform 102, language processing system 104, other server or cloud-based server processing systems and/or one or more entities operating on behalf of or in cooperation with these or other entities. One or more of the operations in the method depicted by FIG. 9 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

In 910, a first query for generating a machine-executable instruction for performing an action of a schema is sent. For example, schema management platform 102 may send such a first query. For example, schema management platform 102 may send a first query to language processing system 104 to generate code for an action within a deterministic action sequence defined in a schema (e.g. code 406). Schema management platform 102 may first construct a prompt (e.g. prompt(s) 138) using prompt template(s) 140, available helper functions (e.g. helper function(s) 144), and user query 402. User query 402 may include a request from a user or system to generate code. Schema management platform 102 may then employ code generation engine 116 to query language processing system 104 using the constructed prompt to obtain code 406.

In 920, a generated machine-executable instruction is received. For example, schema management platform 102 may receive such an instruction. For example, schema management platform 102, in response to sending the first query, may receive code 406 from language processing system 104. In some aspects, code 406 may invoke one or more helper functions that were specified in the first query that was sent to language processing system 104.

In 930, a second query is sent for validating whether the generated instruction performs the action. For example schema management platform 102 may send such a second query. For example, schema management platform 102 may send a second query to language processing system 104 to semantically validate that code 406 performs the specified action in user query 402 when executed. Schema management platform 102 may first construct a second prompt using prompt template(s) 140, available helper functions (e.g. helper function(s) 144), and user query 402. Schema management platform 102 may then transmit the constructed prompt to language processing system 104.

In 940, a positive validation result is received. For example, schema management platform 102 may receive a positive validation result. For example, schema management platform 102 may receive a positive validation result of “Yes” from language processing system 104 indicating that code 406 does perform the specified action in user query 402.

In some aspects, schema management platform 102 may initially receive a negative result of “No” from language processing system 104 indicating that code 406 does not perform the specified schema action or subtask. In some aspects, validation engine 124 (e.g. in addition to a “No” result) may receive feedback 416 explaining why code 406 does not perform the specified schema action or subtask. For example, feedback 416 may identify a specific line or function call that is incorrect within code 406. Code generation 404 may receive feedback 416 and then regenerate code 406 by querying language processing system 104 and/or including feedback 416 inside a constructed prompt.

In response to this query, schema management platform 102 may receive a regenerated instruction from language processing system 104. In some aspects, schema management platform 102 may then update code 406 to be the regenerated instruction to continue the code generation process. Schema management platform 102 may then construct and send another query to language processing system 104 for validating whether code 406 performs the action specified in user query 402 when executed. This process may be repeated until a positive validation result is received, at which point the method continues to 950.

In 950, a third query is sent for generating a unit test for the generated instruction. For example, schema management platform 102 may send such a third query. For example, schema management platform 102, in response to a positive validation result, may construct and send a query to language processing system 104 to generate one or more unit tests for programmatically validating code 406. Unit tests may specify a pass condition and serve as additional programmatic validation for code 406 to verify accuracy and robustness of code 406 generated by language processing system 104. In 960, schema management platform 102 may receive a generated unit test for the generated instruction. For example, schema management platform 102, in response to the third query, may receive a unit test corresponding to code 406 from language processing system 104.

In 970, a positive unit test result is obtained. For example, schema management platform 102 may obtain a positive unit test result. For example, schema management platform 102 may employ validation engine 124 to execute the received unit test using tools interface 128 and/or helper function(s) 144 to obtain a positive unit test “Pass” result indicating that code 406 fulfills the pass condition.

In some aspects, validation engine 124 may initially obtain a negative unit test “Fail” result from executing the received unit test indicating that code 406 does not fulfill the pass condition. In such aspects, schema management platform 102 may construct and send a query to language processing system 104 for determining whether any received unit tests are incorrect (e.g. “Test Fail” case) or whether code 406 is incorrect (e.g. “Code Fail” case).

Upon receiving a determination from language processing system 104 that code 406 is incorrect (“Code Fail”), schema management platform 102 may construct and send another query to language processing system 104 to regenerate code 406. Upon receiving a regenerated instruction, schema management platform 102 may update code 406 to be the regenerated instruction and continue the code validation process (e.g. constructing and sending another query to language processing system 104 to validate whether code 406 performs the specified action). Upon receiving a determination from language processing system 104 that the unit test is incorrect (“Test Fail”), schema management platform 102 may construct and send another query to language processing system 104 to regenerate the unit test (e.g. generate another unit test to programmatically validate code 406). Upon receiving a regenerated unit test, schema management platform may update the generated unit test to be the regenerated unit test and continue the code validation process (e.g. executing the unit test using tools interface 128 and/or helper function(s) 144 to obtain a positive unit test “Pass” result or negative unit test “Fail” result). This process may be repeated until a positive unit test result is obtained, at which point the method continues to 980.

In 980, the generated instruction is assigned to the action. For example, schema management platform 102 may assign the generated instruction to the action. For example, schema management platform 102, in response to obtaining a positive unit test “Pass” result, may leverage propagation engine 120 to assign code 406 that has been validated to the action specified in user query 402. As such, any system looking to execute the schema specified by user query 402 may execute code 406 that has been validated and assigned to the associated action.

In some aspects, the generated instruction may also be propagated to a second action within a different action sequence defined in a different schema. For example, schema management platform 102 may propagate the generated instruction. For example, schema management platform 102 may first determine that the validated code 406 is relevant to a second action of a schema that was not included in user query 402. This determination may be performed using various methods, including but not limited to similarity analysis, semantic search, and language processing system 104. Upon determining the different action to which code 406 could be relevant, schema management platform 102 may employ propagation engine 120 to assign code 406 to the second action.

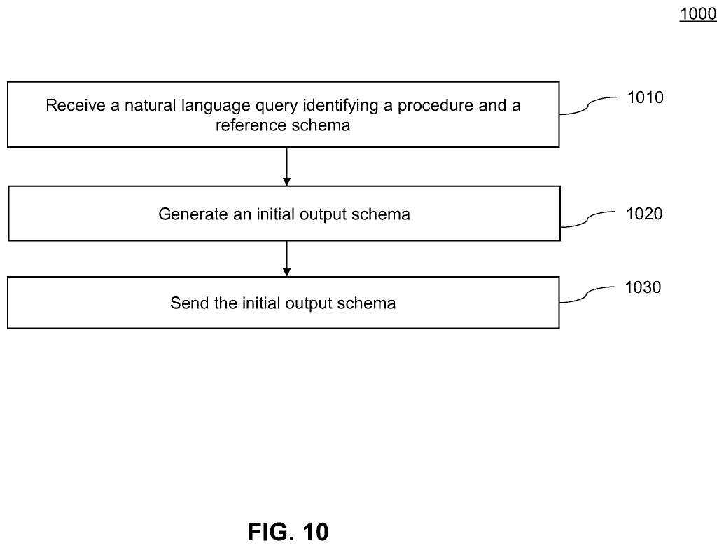

FIG. 10 illustrates another example flow diagram of a method 1000 for generating a schema that may be carried out in line with the discussion above, according to some aspects. Method 1000 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art. Further, method 1000 may not include all the steps illustrated.

Method 1000 shall be described with reference to FIGS. 1 and 2. However, method 1000 is not limited to those example aspects. One or more of the operations in the method depicted by FIG. 10 may be carried out by one or more entities, including, without limitation, schema management platform 102, language processing system 104, other server or cloud-based server processing systems and/or one or more entities operating on behalf of or in cooperation with these or other entities. One or more of the operations in the method depicted by FIG. 10 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

In 1010, a natural language query identifying a procedure and a reference schema is received. For example, language processing system 104 may receive such a query. For example, language processing system 104 may receive a natural language query from schema management platform 102 that identifies a target procedure in a first particular context and a reference schema that defines a deterministic action sequence for performing another procedure in the same or a similar context. In some aspects, the natural language query may also include additional potentially relevant records, such as operating manuals, conversation data, subject matter expertise, and the like.

In 1020, an initial output schema is generated. For example, language processing system 104 may generate an initial output schema. For example, language processing system 104 may leverage one or more of language models 148 to generate an initial output schema defining an initial action sequence for performing the target procedure (e.g. output schema 210) based on the natural language query from schema management platform 102. In generating the initial output schema, language processing system 104 may employ various techniques including, but not limited to multi-head self-attention mechanisms, positional encoding, layer normalization, masked autoregressive decoding nucleus sampling, softmax token distribution computation, and key-value cache optimization. Output schema 210 may initially not define a fully deterministic sequence of actions for performing a procedure.

In 1030, the initial output schema is sent. For example, language processing system 104 may send output schema 210 to schema management platform 102. At schema management platform 102, output schema 210 may then be used to generate a final output schema that defines a deterministic action sequence for performing the target procedure. The final generated output schema may provide a deterministic result when executed.

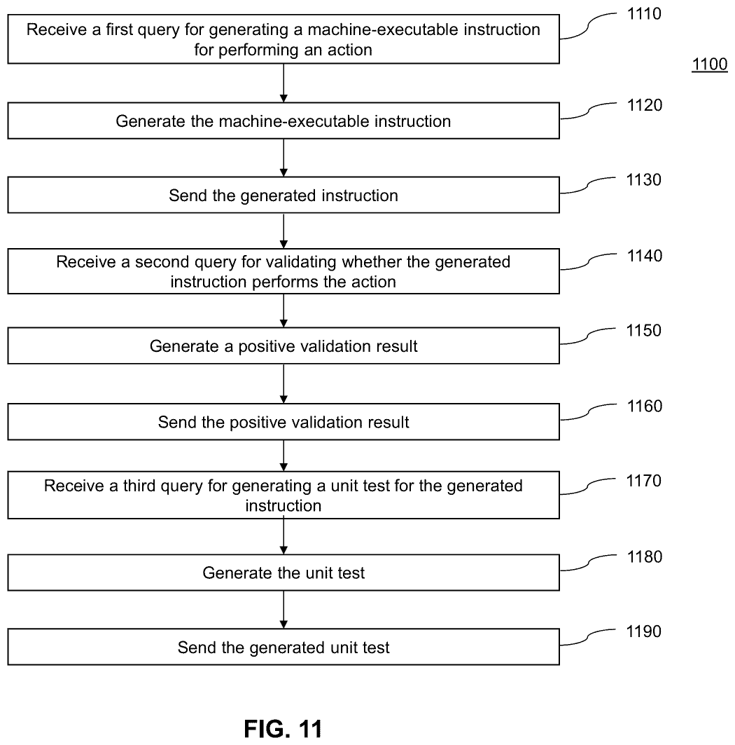

FIG. 11 illustrates another example flow diagram of a method 1100 for generating code for a schema that may be carried out in line with the discussion above, according to some aspects. Method 1100 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art. Further, method 1100 may not include all the steps illustrated.

Method 1100 shall be described with reference to FIGS. 1 and 4. However, method 1100 is not limited to those example aspects. One or more of the operations in the method depicted by FIG. 11 may be carried out by one or more entities, including, without limitation, schema management platform 102, language processing system 104, other server or cloud-based server processing systems and/or one or more entities operating on behalf of or in cooperation with these or other entities. One or more of the operations in the method depicted by FIG. 11 may also or instead be carried out by one or more servers of an enterprise network and/or a cloud computing network and accessed via a client computer system that is connected thereto. Any such entity may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

In 1110, a first query is received for generating a machine-executable instruction for performing an action. The first query may be received by a language processing system that is the same as or different from a language processing system that performs method 1000. For example, language processing system 104 may receive such a first query. For example, language processing system 104 may receive a first query from schema management platform 102 to generate code for an action within a deterministic action sequence defined in a schema (e.g. code 406). The first query may include the associated schema and action and any available helper functions (e.g. helper function(s) 144) that may be relevant for generating code 406.

In 1120, the machine-executable instruction is generated. For example, language processing system 104 may generate the machine-executable instruction. For example, language processing system 104 may leverage one or more of language models 148 to generate code 406 based on the first query from schema management platform 102. In 1130, language processing system 104 may send the generated instruction. For example, language processing system 104, upon generating code 406, may send code 406 to schema management platform 102.

In 1140, a second query is received for validating whether the generated instruction performs the action. For example, language processing system 104 may receive such a second query. For example, language processing system 104 may receive a second query from schema management platform 102 for semantically validating that code 406 performs the specified action from the first query when executed. The second query may include any available helper functions (e.g. helper function(s) 144) that may be helpful for semantically validating code 406.

In 1150, a positive validation result is generated. For example, language processing system 104 may generate a positive validation result. For example, language processing system 104, based on the second query, may leverage one or more of language models 148 to generate a positive validation result of “Yes” indicating that code 406 performs the specified action when executed. A language model 148 used in 1150 may be the same or different from a language model 148 used in method 1000, and may be the same or different from a language model 148 used in 1120.

In some aspects, language processing system 104 may alternatively generate a negative result of “No” indicating that code 406 does not perform the specified action. In such aspects, language processing system 104 may also generate feedback 416 explaining why code 406 does not perform the specified schema action or subtask. For example, feedback 416 may identify a specific line or function call that is incorrect within code 406. Language processing system 104 may then send the negative validation result of “No” to schema management platform 102. Follow-up queries may then be received from schema management platform 102, and the above steps are repeated until a positive validation result is generated.

In 1160, the positive validation result is sent. For example, language processing system 104 may send the positive validation result. For example, language processing system 104 may send the positive validation result of “Yes” to schema management platform 102 in response to the second query.

In 1170, a third query is received for generating a unit test for the generated instruction. For example, language processing system 104 may receive such a third query. For example, language processing system 104 may receive a third query from schema management platform 102 for generating one or more unit tests for programmatically validating code 406. The one or more unit tests may each specify a pass condition and serve as additional programmatic validation for code 406 to verify accuracy and robustness of code 406 generated by language processing system 104.

In 1180, the unit test is generated. For example, language processing system 104 may generate the unit test. For example, language processing system 104 may leverage one or more of language models 148 to generate the unit test for programmatically validating code 406 based on the third query. A language model 148 used in 1180 may be the same or different from a language model 148 used in method 1000, and may be the same or different from a language model 148 used in either or both of 1120 and 1150.

In 1190, the generated unit test is sent. For example, language processing system 104 may send the generated unit test to schema management platform 102.

In some aspects, a fourth query may be received indicating that the unit test has failed. For example, language processing system 104 may receive a fourth query from schema management platform 102 for determining the fail condition for a “Fail” unit test result. Language processing system 104 may then leverage one or more of language models 148 to determine whether the one or more generated unit tests are incorrect (e.g. “Test Fail” case) or whether code 406 is incorrect (e.g. “Code Fail” case). Upon determining the unit test fail condition, language processing system 104 may send the unit test fail condition to schema management platform 102. In line with the discussion above, in generating any one of code 406, the positive validation result, the negative validation result, feedback 416, one or more unit tests, and one or more unit test fail condition, language processing system 104 may employ various techniques including, but not limited to multi-head self-attention mechanisms, positional encoding, layer normalization, masked autoregressive decoding nucleus sampling, softmax token distribution computation, and key-value cache optimization.

FIG. 12 depicts an example computer system useful for implementing various aspects described herein.

Various aspects may be implemented, for example, using one or more well-known computer systems, such as computer system 1200 shown in FIG. 12. One or more computer systems 1200 may be used, for example, to implement any of the aspects discussed herein, as well as combinations and sub-combinations thereof. For example, the example computer system may be implemented as part of client device 102, server 118, etc. Cloud implementations may include one or more of the example computer systems operating locally or distributed across one or more server sites.

Computer system 1200 may include one or more processors (also called central processing units, or CPUs), such as a processor 1204. Processor 1204 may be connected to a communication infrastructure or bus 1206.

Computer system 1200 may also include customer input/output device(s) 1202, such as monitors, keyboards, pointing devices, etc., which may communicate with communication infrastructure 1206 through customer input/output interface(s) 1202.

One or more of processors 1204 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1216. Removable storage unit 1216 may include a computer usable or readable storage device having stored thereon computer software (control logic) and/or data. Removable storage unit 1216 may be a floppy disk, magnetic tape, compact disk, DVD, optical storage disk, and/any other computer data storage device. Removable storage drive 1214 may read from and/or write to removable storage unit 1216.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1216 and 1222, as well as tangible articles of manufacture embodying any combination of the foregoing. Such control logic, when executed by one or more data processing devices (such as computer system 1200), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 12. In particular, aspects can operate with software, hardware, and/or operating system implementations other than those described herein.

Various aspects of the present disclosure include systems, methods, and non-transitory computer-readable media configured to: receive a first natural language query identifying a target procedure in a particular context; determine, based on the first natural language query, a reference schema for the target procedure from among a plurality of stored schemas, wherein each schema of the plurality of stored schemas defines a respective deterministic action sequence for performing a respective procedure in a respective context; construct a second natural language query based on the first natural language query and the reference schema; send, to a multimodal model, the second natural language query; receive, from the multimodal model, an initial output schema based on the second natural language query, the initial output schema defining an initial action sequence for performing the target procedure; verify a construction of the initial action sequence; and generate, based on the verifying, a final output schema that defines a deterministic action sequence for performing the target procedure, wherein the final output schema provides a deterministic result when executed.

In such aspects, determining the reference schema may comprise performing at least one of a Boolean database search, a natural language search, or a vector similarity algorithm on the plurality of stored schemas against the first natural language query. Generating the final output schema may comprise updating, in response to a failed construction verification, the initial action sequence of the initial output schema to the deterministic action sequence. In some aspects, generating the final output schema may comprise using, in response to a positive construction verification, the initial action sequence as the deterministic action sequence. The second natural language query may further comprise information related to the particular context. In some aspects, the information related to the particular context may comprise at least one of a user manual an enterprise repository, or expert information. The target procedure may comprise diagnosing or troubleshooting an issue with an industrial machine. In some aspects, receiving the first natural language query may comprise: mining information regarding the particular context to obtain the target procedure; and constructing the natural language query based on the mining. Mining the information regarding the particular context may comprise mining at least one of conversation data or video data related to the particular context.

Various additional aspects of the present disclosure include systems, methods, and non-transitory computer-readable media configured to: send, to a language processing system having one or more multimodal models, a first query for generating a machine-executable instruction for performing an action within a deterministic action sequence defined in a schema, wherein the deterministic action sequence defined in the schema performs a respective procedure in a particular context; receive, from the language processing system, a generated machine-executable instruction based on the first query; send, to the language processing system, a second query for validating whether the generated instruction performs the action when executed; receive, from the language processing system, a positive validation result indicating that the generated instruction performs the action when executed; send, to the language processing system and based on the positive validation result, a third query for generating a unit test for the generated instruction, wherein the unit test specifies a pass condition; receive, from the language processing system, a generated unit test for the generated instruction; obtain, by executing the unit test, a positive unit test result indicating that the generated instruction fulfills the pass condition; and assign, based on the positive unit test result, the generated instruction to the action, wherein an execution of the action comprises executing the generated instruction.

Systems, methods, and non-transitory computer-readable media of such additional aspects may be further configured to, prior to receiving the positive validation result: receive, from the language processing system, a negative validation result indicating that the generated instruction does not perform the action when executed and a text feedback comprising a reason why the generated instruction does not perform the action; construct, based on the text feedback, a fourth query for regenerating the instruction; send, to the language processing system, the fourth query; receive, from the language processing system, a regenerated instruction; update the generated instruction to be the regenerated instruction; and send, to the multimodal model, a fifth query for validating whether the generated instruction performs the action when executed. The first query may specify a helper function and a description of a functionality of the helper function. Alternatively or additionally, the generated instruction may invoke the helper function.

Alternatively or additionally, systems, methods, and non-transitory computer-readable media of such additional aspects may be further configured to, before receiving the positive unit test result: obtain, by executing the unit test, a negative unit test result indicating that the generated instruction does not fulfill the pass condition; send, based on the negative unit test result, a sixth query for determining whether the generated instruction or the unit test is incorrect to the multimodal model; receive, from the multimodal model, a determination indicating that the generated instruction is incorrect; send, based on the determination, a seventh query for regenerating the instruction to the multimodal model; receive, from the multimodal model, a regenerated instruction; and update the generated instruction to be the regenerated instruction. In some aspects, systems, methods, and non-transitory computer-readable media of such additional aspects may be further configured to: determine that the generated instruction is relevant to a second action within a different action sequence defined in a different schema; and propagate the generated instruction to the second action. Propagating the generated instruction may comprise assigning, to the second action, a new machine-executable instruction that is based on the generated instruction.

Various further aspects of the present disclosure include systems, methods, and non-transitory computer-readable media configured to: receive a natural language query identifying a target procedure in a particular context; determine, based on the natural language query, a relevant schema defining a deterministic action sequence for performing the target procedure from among a plurality of stored schemas; assign, by an orchestrator, a plurality of agents to execute the relevant schema; instruct a first agent to perform a first action within the deterministic action sequence to obtain an agent decision; determine, based on the agent decision, one or more additional actions within the deterministic action sequence to perform; instruct one or more additional agents to perform the one or more additional actions to obtain a final schema result; and complete the target procedure based on the final schema result.

In such further aspects, instructing the first agent to perform the first action may comprise executing, via the first agent, a machine-executable instruction assigned to the first action. Systems, methods, and non-transitory computer-readable media of such further aspects may be further configured to: receive a secondary result for the target procedure based on an undefined action that is not within the deterministic action sequence; and update the reference schema to define the undefined action and the secondary result. Each agent in the plurality of agents may employ one or more tools to perform a respective assigned action. The one or more tools may comprise one or more of a multimodal model, a machine learning model, a data model, an application platform interface, or a helper function.

Various other aspects of the present disclosure also include systems, methods, and non-transitory computer-readable media configured to: receive, from a schema management platform, a natural language query identifying a first procedure in a first context and a reference schema for the first procedure, wherein the reference schema defines a deterministic action sequence for performing a second procedure in a second context; generate an initial output schema based on the natural language query, the initial output schema defining an initial action sequence for performing the first procedure; and send, to the schema management platform, the initial output schema, wherein the initial output schema is used to generate a final output schema that defines a deterministic action sequence for performing the target procedure and the final output schema provides a deterministic result when executed. In such other aspects, generating the initial output schema may comprise employing one or more agents to action the natural language query. In some aspects, systems, methods, and non-transitory computer-readable media of such other aspects may be further configured to: receive, from the one or more agents, an additional prompt for iterative processing.

Various aspects of the present disclosure also include systems, methods, and non-transitory computer-readable media configured to: receive, from a schema management platform, a first query for generating a machine-executable instruction for performing an action within a deterministic action sequence defined in a schema; generate the machine-executable instruction based on the first query; send, to the schema management platform, the generated machine-executable instruction; receive, from the schema management platform, a second query for validating whether the generated instruction performs the action when executed; generate, based on the second query, a positive validation result indicating that the generated instruction performs the action when executed; send, to the schema management platform, the positive validation result; receive, from the schema management platform, a third query for generating a unit test for the generated instruction; generate the unit test based on the third query; and send, to the schema management platform, the generated unit test.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

Aspects of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

What is claimed is:

1. A computer-implemented method, comprising:
receiving a first natural language query identifying a target procedure in a particular context;
determining, based on the first natural language query, a reference schema for the target procedure from among a plurality of stored schemas, wherein each schema of the plurality of stored schemas defines a respective deterministic action sequence for performing a respective procedure in a respective context;
constructing a second natural language query based on the first natural language query and the reference schema;
sending, to a multimodal model, the second natural language query;
receiving, from the multimodal model, an initial output schema based on the second natural language query, the initial output schema defining an initial action sequence for performing the target procedure;
verifying a construction of the initial action sequence; and
generating, based on the verifying, a final output schema that defines a deterministic action sequence for performing the target procedure, wherein the final output schema provides a deterministic result when executed.

2. The computer-implemented method of claim 1, wherein the determining comprises:
performing at least one of a Boolean database search, a natural language search, or a vector similarity algorithm on the plurality of stored schemas against the first natural language query.

3. The computer-implemented method of claim 1, wherein the generating comprises:
updating, in response to a failed construction verification, the initial action sequence of the initial output schema to the deterministic action sequence.

4. The computer-implemented method of claim 1, wherein the generating comprises:
using, in response to a positive construction verification, the initial action sequence as the deterministic action sequence.

5. The computer-implemented method of claim 1, wherein the second natural language query further comprises information related to the particular context.

6. The computer-implemented method of claim 5, wherein the information related to the particular context comprises at least one of a user manual, an enterprise repository, or expert information.

7. The computer-implemented method of claim 1, further comprising:
executing the final output schema to obtain the deterministic result for the target procedure.

8. The computer-implemented method of claim 1, wherein the target procedure comprises diagnosing or troubleshooting an issue with an industrial machine.

9. The computer-implemented method of claim 1, wherein the receiving the query comprises:
mining information regarding the particular context to obtain the target procedure; and
constructing the natural language query based on the mining.

10. The computer-implemented method of claim 9, wherein the mining comprises mining at least one of conversation data or video data related to the particular context.

11. The computer-implemented method of claim 1, further comprising:
assigning, by an orchestrator, a plurality of agents to execute the final output schema;
instructing a first agent to perform a first action within the deterministic action sequence to obtain an agent decision;
determining, based on the agent decision, one or more additional actions within the deterministic action sequence to perform;
instructing one or more additional agents to perform the one or more additional actions to obtain a final schema result; and
completing the target procedure based on the final schema result.

12. A computer-implemented method, comprising:
sending, to a language processing system having one or more multimodal models, a first query for generating a machine-executable instruction for performing an action within a deterministic action sequence defined in a schema, wherein the deterministic action sequence defined in the schema performs a respective procedure in a particular context;
receiving, from the language processing system, a generated machine-executable instruction based on the first query;
sending, to the language processing system, a second query for validating whether the generated instruction performs the action when executed;
receiving, from the language processing system, a positive validation result indicating that the generated instruction performs the action when executed;
sending, to the language processing system and based on the positive validation result, a third query for generating a unit test for the generated instruction, wherein the unit test specifies a pass condition;
receiving, from the language processing system, a generated unit test for the generated instruction;
obtaining, by executing the unit test, a positive unit test result indicating that the generated instruction fulfills the pass condition; and
assigning, based on the positive unit test result, the generated instruction to the action, wherein an execution of the action comprises executing the generated instruction.

13. The computer-implemented method of claim 12, further comprising, prior to receiving the positive validation result:
receiving, from the language processing system, a negative validation result indicating that the generated instruction does not perform the action when executed and a text feedback comprising a reason why the generated instruction does not perform the action;
constructing, based on the text feedback, a fourth query for regenerating the instruction;
sending, to the language processing system, the fourth query;
receiving, from the language processing system, a regenerated instruction;
updating the generated instruction to be the regenerated instruction; and
sending, to the multimodal model, a fifth query for validating whether the generated instruction performs the action when executed.

14. The computer-implemented method of claim 12, wherein:
the first query specifies a helper function and a description of a functionality of the helper function, and
the generated instruction invokes the helper function.

15. The computer-implemented method of claim 12, further comprising, before receiving the positive unit test result:
obtaining, by executing the unit test, a negative unit test result indicating that the generated instruction does not fulfill the pass condition;
sending, based on the negative unit test result, a sixth query for determining whether the generated instruction or the unit test is incorrect to the multimodal model;
receiving, from the multimodal model, a determination indicating that the generated instruction is incorrect;
sending, based on the determination, a seventh query for regenerating the instruction to the multimodal model;
receiving, from the multimodal model, a regenerated instruction; and
updating the generated instruction to be the regenerated instruction.

16. The computer-implemented method of claim 12, further comprising:
determining that the generated instruction is relevant to a second action within a different action sequence defined in a different schema; and
propagating the generated instruction to the second action.

17. The computer-implemented method of claim 16, wherein the propagating comprises:
assigning, to the second action, a new machine-executable instruction that is based on the generated instruction.

18. A computer-implemented method, comprising:
receiving, from a schema management platform, a natural language query identifying a first procedure in a first context and a reference schema for the first procedure, wherein the reference schema defines a deterministic action sequence for performing a second procedure in a second context;
generating an initial output schema based on the natural language query, the initial output schema defining an initial action sequence for performing the first procedure; and
sending, to the schema management platform, the initial output schema, wherein the initial output schema is used to generate a final output schema that defines a deterministic action sequence for performing the first procedure and the final output schema provides a deterministic result when executed.

19. The computer-implemented method of claim 18, wherein the generating comprises:
employing one or more agents to action the natural language query.

20. The computer-implemented method of claim 19, wherein the generating further comprises:
receiving, from the one or more agents, an additional prompt for iterative processing,
wherein the initial output schema is based on the natural language query and the additional prompt.
